(19) United States
(12) Patent Application Publication
(10) Pub. No.: US 2002/0165744 A1
(43) Pub. Date: Nov. 7, 2002

(54) Product development process

(76) Inventors: Michael F. Juras, Bloomfield Hills, MI (US); Michael G. Fecek, Rochester Hills, MI (US)

Correspondence Address: YOUNG & BASILE, P.C., Suite 624, 3001 West Big Beaver Road, Troy, MI, 48084-3107, US

(21) Appl. No.: 09/993,845

(22) Filed: Nov. 16, 2001

Related U.S. Application Data
(60) Provisional application No. 60/249,174, filed on Nov. 16, 2000.

(51) Int. Cl. G06F 17/60

(52) U.S. Cl. 705/7

(57) ABSTRACT

A product development process which is capable of generating an estimate of the cost of developing and manufacturing the product as well as developing a plan to manufacture the product including parallel stages of product design, dimensional integration and manufacturing processes. At least two distinct levels of information are provided in the estimate generation, each level increasing in detail from a broad category first level to more detailed sub-levels. The plan includes the steps of defining customer deliverables, defining aids to create the customer deliverables and defining analysis steps to support the deliverables. Each of these steps are divided into sequential time cells.

### CROSS-REFERENCE TO CO-PENDING APPLICATION

This application claims the benefit of the filing date of co-pending Provisional Patent Application Serial No. 60/249,174, filed Nov. 16, 2000 in the name of Michael F. Juras and entitled “Product Development Plan and Implementation Process”, the entire contents of which are incorporated herein in its entirety.

### BACKGROUND OF THE INVENTION

Typically, the development of a product requires interaction between three disciplines: product design, dimensional management and manufacturing or process design. The process can start when a manufacturer receives a customer request for quote to build a particular product. The manufacturer then develops and manages quotes, creates a strategic plan and program concept, develops the product and the process to manufacture the product, and then launches product production and manufacturing process support.

However, the typical product development process has been more sequential than parallel, thereby taking a considerable amount of time from an initial request for quote to the final production of the product. Further, at each step during the product development process, the individuals responsible for various elements of the product development often do not have access to the latest engineering or financial information. This creates problems in creating an accurate quote as well as difficulties in developing and launching a product at a defined price and profit margin.

What is needed is a product development process which overcomes the problems encountered with the previously defined processes used for development of a product.

### SUMMARY

The present invention is a method for developing a product which overcomes many deficiencies in previously devised product development processes or models.

In one aspect, the present method includes the steps of:

generating an estimate of the cost of developing and manufacturing the product, and developing a plan to manufacture the product including parallel stages of product design, dimensional integration and manufacturing processes.

The step of generating the estimate further comprises the step of providing at least two distinct levels of information to support each one of a data entry field in the estimate, each level increasing in detail from a broad first level.

The step of developing the plan also includes the steps of defining customer deliverables, defining aids to create the customer deliverables, and defining analysis steps to support the deliverables.

The step of defining each of the customer deliverables, aids and analysis are further divided into sequential time cells.

In another aspect of the invention the method includes the steps of generating an estimate of the cost of developing and manufacturing a product in response to a request for estimate for setting product requirements. The step of generating the estimate includes providing at least two distinct levels of estimate information to support each one of a data entry field in the estimate. Each level increasing in detail from a broad first level through each successive lower level.

The product development method of the present invention affords many advantages over previously devised product development methods or models.

The present product development method includes a unique request for “module” which enables a user to promptly respond to a request for an estimate of the development and manufacture of a product. The user can uniquely select between multiple levels of detail in formulating the estimate based on the user's preference, available response time and acceptable risk factors.

The unique developmental model of the present invention provides parallel scheduling of product design, dimensional analysis and manufacturing. This shortens the overall product process as compared to previous product development models which use a more common time sequence of product design, followed by dimensional analysis which is then followed by the development of the manufacturing process for the product.

### BRIEF DESCRIPTION OF THE DRAWINGS

The various features, advantages and other uses for the present invention will become more apparent by referring to the following detailed description and drawing in which:

FIG. 1 is a pictorial representation of the product development process according to the present invention;

FIG. 2 is a flow diagram of the RFQ process according to the present invention;

FIGS. 3-15 are screen display templates used in the operation of the RFQ process according to the present invention;

FIG. 16 is a pictorial representation of the main elements of the product development process according to the present invention;

FIG. 17 is a graphical interface program set-up sheet shown generally in FIG. 1;

FIG. 18 is a flow diagram depicting the validation of the design, dimensional management and manufacturing stages of the set-up sheet;

FIG. 19 is an example of a completed set-up sheet;

FIG. 20 is a screen display of an input chart for entering specific work products and the corresponding resources and attributes in the design phase of the set up sheet;

FIG. 21 is a pictorial representation of a timing/scheduling screen of the program set up sheet of the present invention;

FIG. 22 is a screen display of a program management chart for entry of financial information on a periodic basis;

FIG. 23 is a screen display of a design plan input chart including resources and attributes;

FIG. 24 is a screen display of the work product entry portion of the design analysis phase of the program set-up sheet of the present invention;

FIG. 25 is a screen display of a data entry chart for design product aids according to the present program set-up sheet;

FIG. 26 is a screen display of a work product entry chart for the validation phase of the present program set-up sheet;

FIG. 27 is a budget chart of the program set-up sheet of the present invention;

FIG. 28 is a budget performance chart used in the program set-up sheet of the present invention;

FIG. 29 is a pictorial representation of a cost summary screen according to the present invention;

FIG. 30 is a screen display of a timing-program management business plan according to the present invention; and

FIGS. 31A-31L are screen displays of the program setup templates used in the present invention.

### DETAILED DESCRIPTION

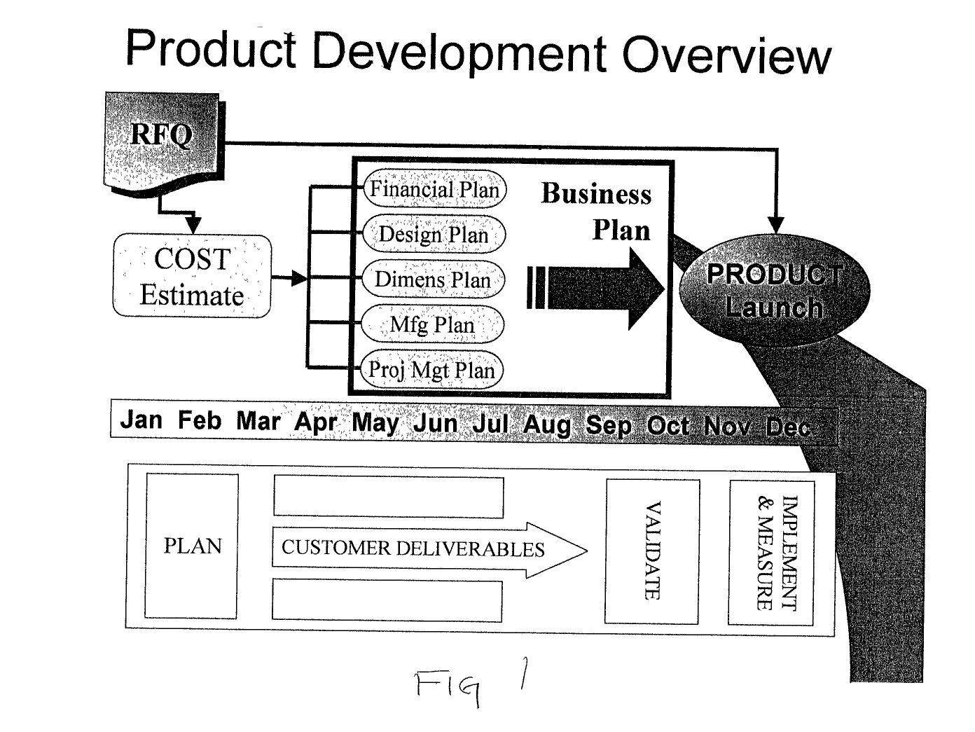

As shown in FIG. 1, the present invention is a product development process which takes development of a product from an initial Request For Estimate (RFE), through the creation of a product development or business plan to an implementation of the plan for a product launch. The product development process sets up a time schedule for delivering the contracted deliverables to the customer.

The product development process uses tools embodied in software which provide a structured process for developing quotes, creating business and functional work plans, and managing operations to design and build manufacturing systems to manufacture and deliver the contracted product to the customer. The tools include a menu structure, plant layout, product development and process flow chart.

The product development tools of the present invention utilize a web or internet server having browser interface for inter-connecting a multi-plant company as well as a company supply chain to its suppliers.

The computer network can comprise a local area network formed of one main computer and a number of separate computers connected together by means of computer datalines. Alternately, the remote terminals or nodes can be separated by great distances, with data communication taking place by a number of different communication means, including satellite communication, land line communication, the Internet or World Wide Web, or combinations thereof

The product development process generates a bill of material shown in FIG. 32. The product bill of material breaks down into smaller details from subsystems to assemblies and to components. A manufacturing bill of material is derived from the product bill of material that breaks down into plant, line, station, tool, assemblies and components. The level of detail is under direct control of a user.

Further, the present process development system is versatile in that an RFE and/or a plan can be developed for the entire product, or any subsystem, assembly or component of the product. This enables the product development process to meet the needs of a multi-plant company as well as a tiered supply chain between a company and its suppliers who have different amounts of responsibility for developing the subsystem, assemblies or components for the assemblies of each product.

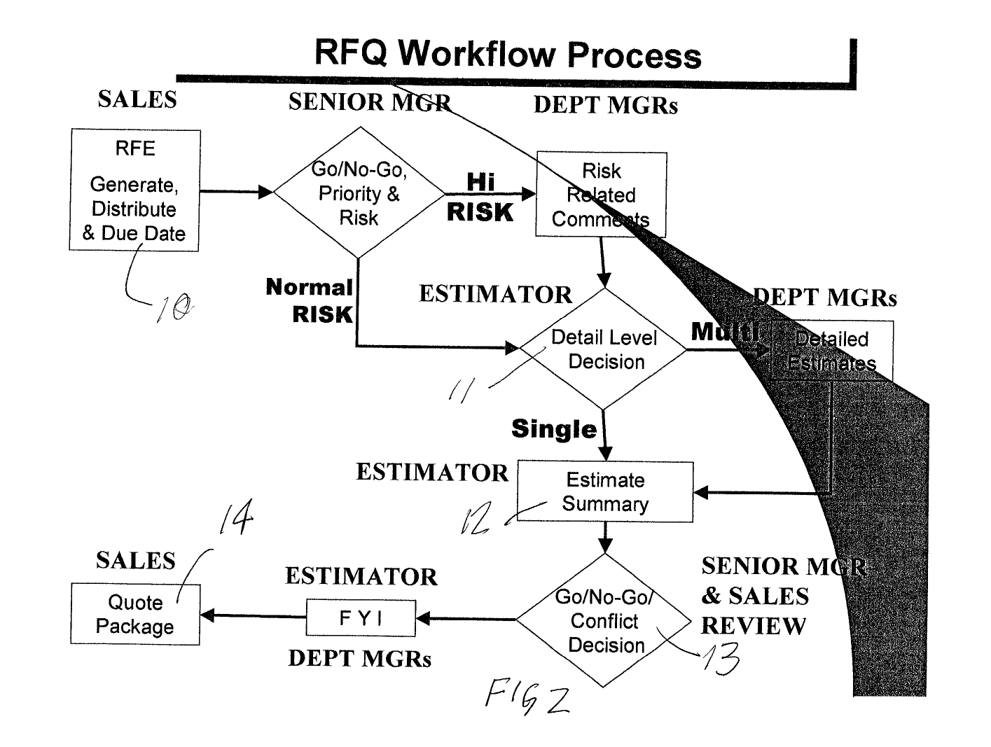

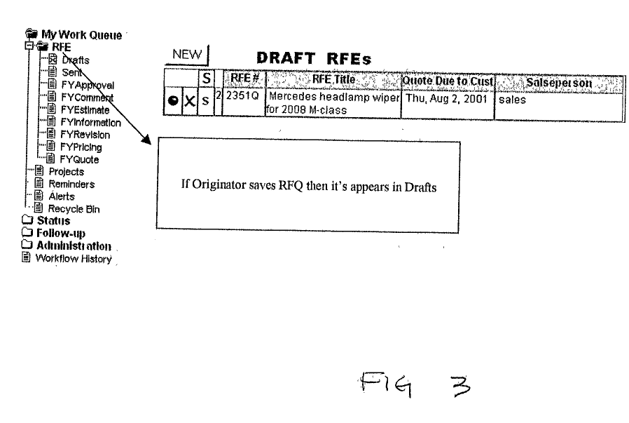

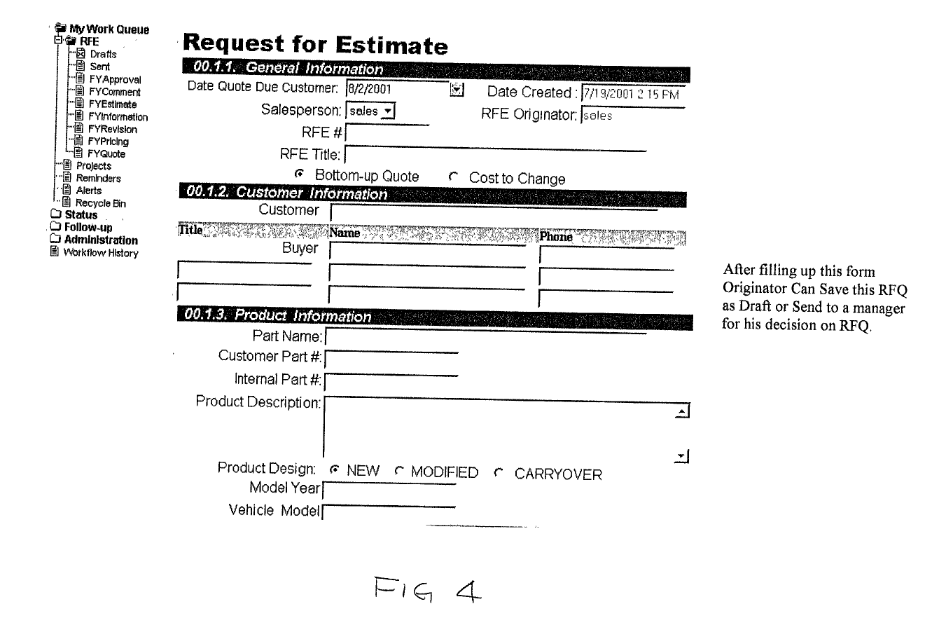

FIG. 2 depicts the RFQ work flow process of the present invention. The quoting or estimating process starts with an originating user opening a new RFE (Request for Estimate) screen shown in FIG. 3 in response to an RFE from a potential customer. The menu on the left side of the screen shows the various selectable screens used in the RFE process. When the general “RFE” menu is selected, the indented menu items appear to enable an originator to prepare, save and obtain approval and estimates of an RFE. When a new RFE draft is originated, the screen shown in FIG. 4 is generated by the program development software and includes a number of entry fields for a user to input information concerning the customer and product in question.

Table A depicts the selectable menu entries for each authorized user for the present product development program under the heading “My Work Queue”. This menu listing provides the various selectable screens and activities which a user can employ to review, input, edit or approve various activities in the RFQ process.

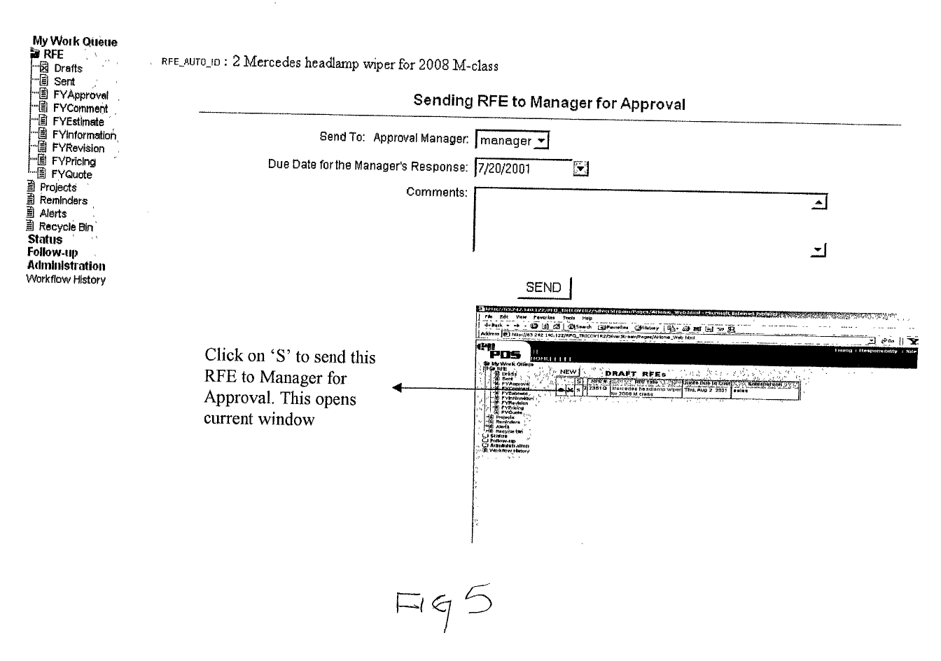

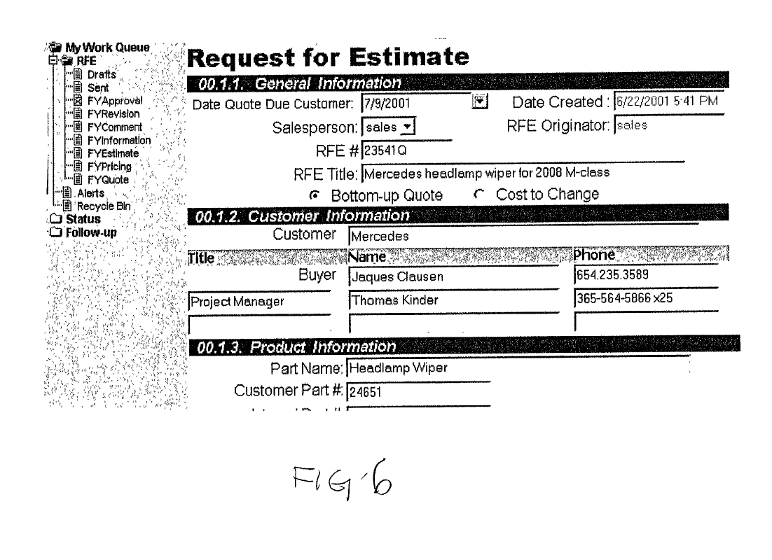

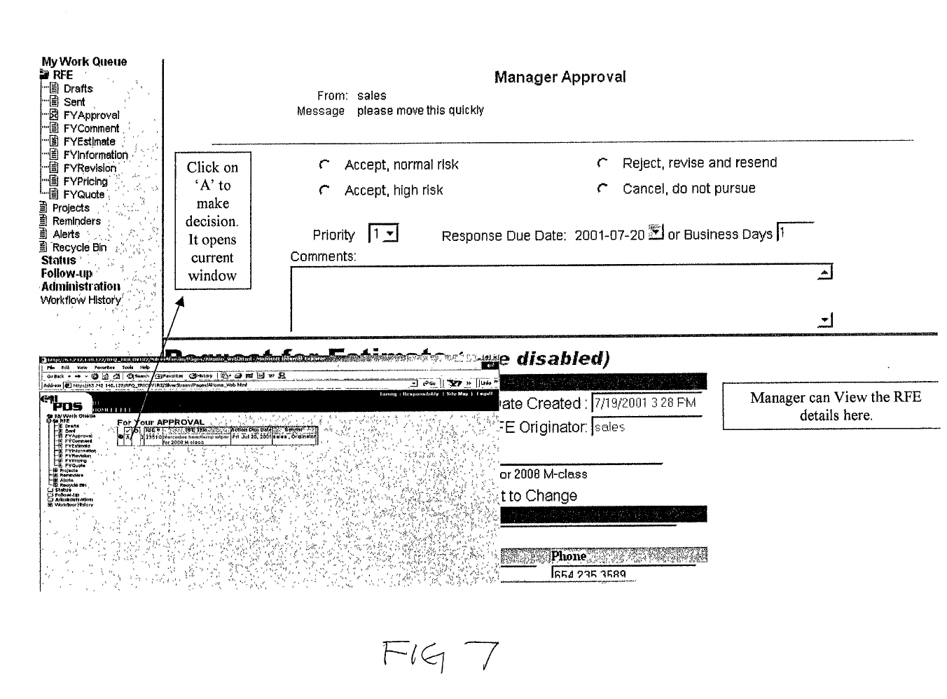

The user has the ability to save an RFE until he is satisfied with the information. At this time, the user can send the RFE to a manager for approval as shown in the screen depicted in FIG. 5. The completed RFE shown in FIG. 6 is an example of an RFE sent to a manager for approval. The manager, as shown in FIG. 2, can give a go or no-go decision based on priority and risk factors. The manager can access the screen shown in FIG. 7 by an appropriate “click” on the left side menu and can enter his/her acceptance, rejection or cancellation decision. The manager can also view the entire RFE details as shown in FIG. 6.

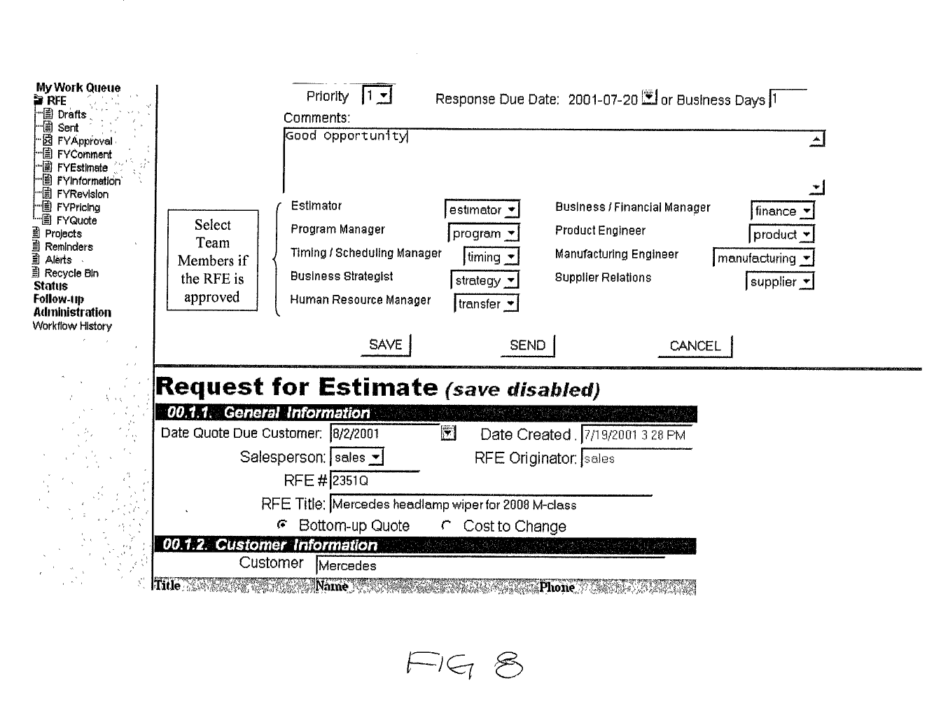

If an RFE is approved, the manager can select the screen shown in FIG. 8 to input product team members.

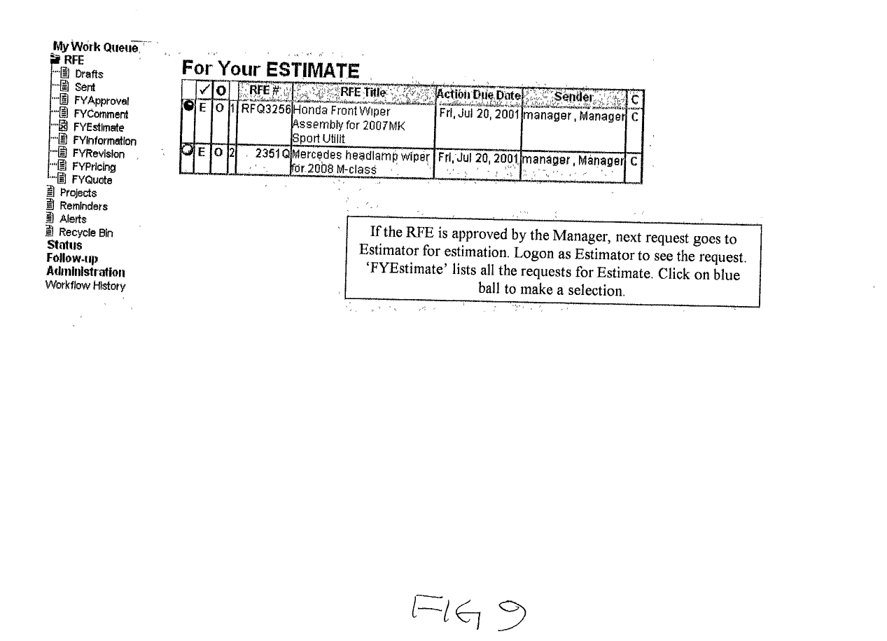

Next, as shown in step 11 in FIG. 2, the RFE is then sent to an estimator for estimation. The screen shown in FIG. 9 is opened by the designated estimator who can then click on the appropriate ball on the left side of the display fields showing all of the outstanding RFE's and to view the details of the RFE.

The product development process of the present invention includes a unique multi-tiered estimation and plan system wherein costs for various activities, such as engineering, material, labor and burden piece cost, etc., can be estimated or input in a broad summary spreadsheet, to a more detailed material-labor-burden worksheet, and to a complete business plan sheet.

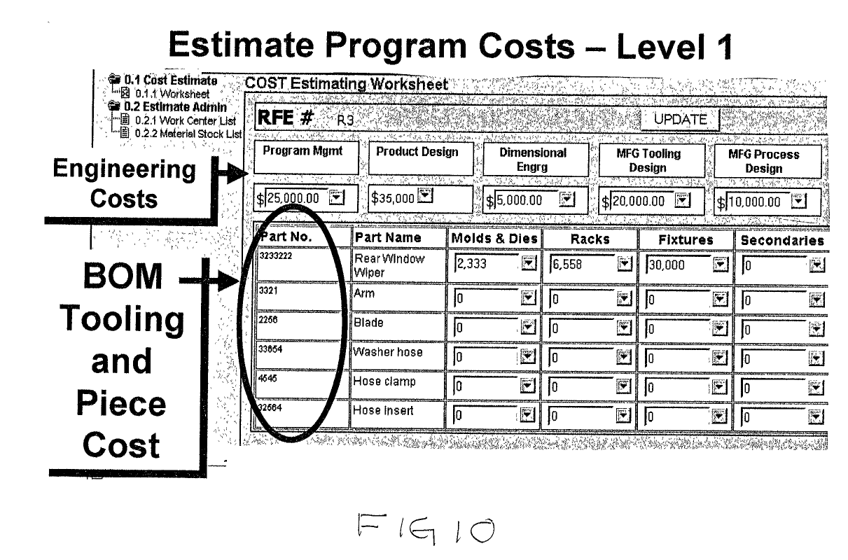

FIG. 10 depicts the broad summary or level 1 spreadsheet screen which a cost estimator can use to estimate engineering costs for various program development activities, such as program management, product design, dimensional engineering, manufacturing tooling design and manufacturing process design. The boxes shown under these activity headings in FIG. 10 depict enterable fields where an estimator can input a cost estimate for the particular activity or item. Alternately, the process development software is upward linked from the second and third levels to provide more detailed information. As shown for the heading “product design” in FIG. 10, when a more detailed spreadsheet has been prepared, the enterable field box disappears. This is an indication to an individual reviewing the screen shown in FIG. 10 that more detailed information is available to support the estimated dollar amount.

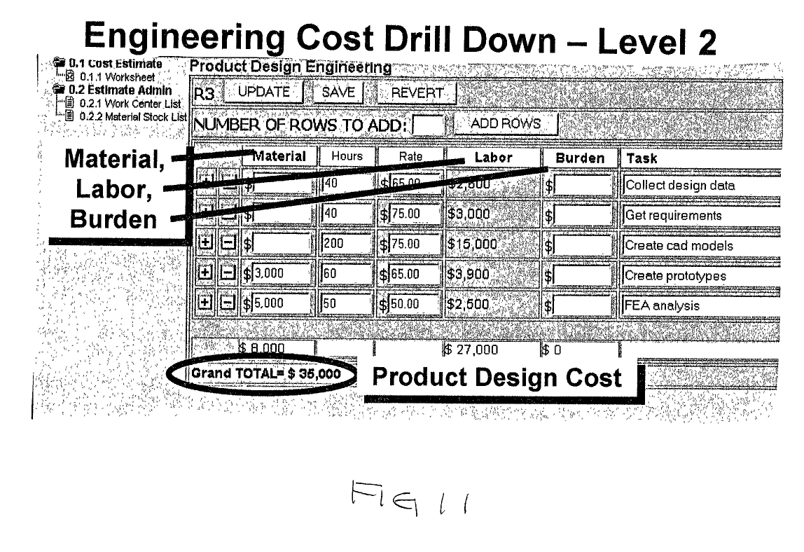

For any of the parts forming the product shown in FIG. 10, an estimator can click down to a more detailed level shown as level 2 in FIG. 11. This screen provides enterable data fields for material, labor and burden for a particular product or product component.

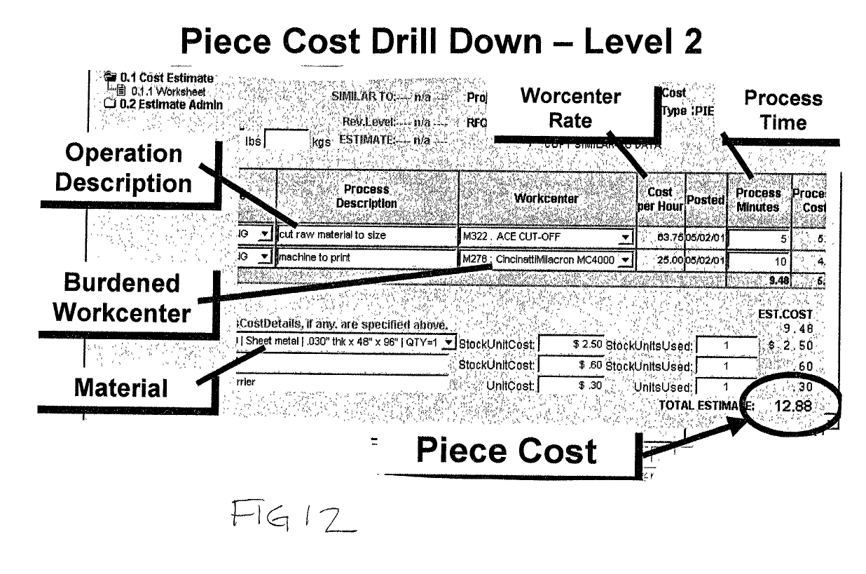

FIG. 12 depicts a level 2 spreadsheet or screen for developing more detailed piece cost information. Enterable data fields allow an estimator to input the specific work center or machine needed to implement the particular process step. Material and material costs are also provided to develop a detailed piece cost.

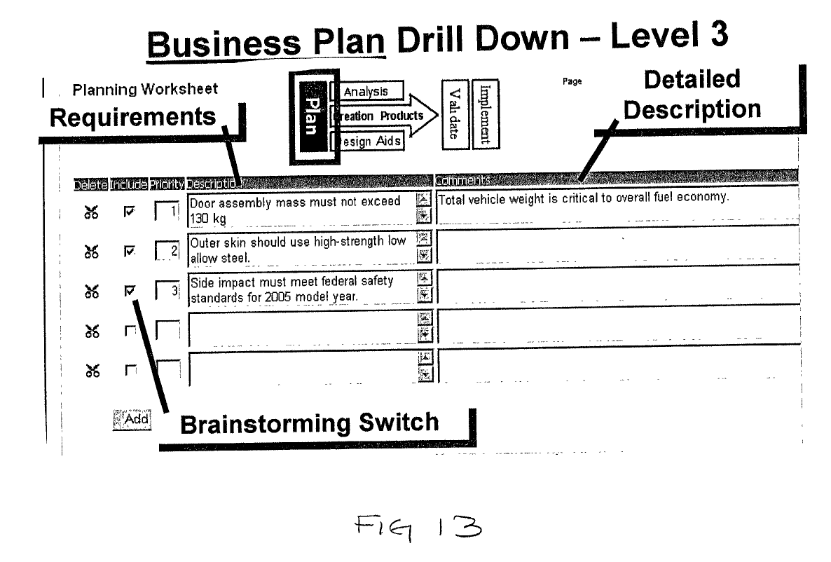

Depending upon how much of the business plan has been developed, an estimator can click down to a third more detailed level shown in FIGS. 13, 14 and 15. As shown in FIG. 13, product planning requirements can be described along with various comments. A brainstorming switch is provided to ask other project team members for comments. The process also includes a priority ranking of the planning requirements.

If the plan is in the deliverable stage, the screen shown in FIG. 14 can be used to describe each work product as well as the detailed work plan required to create the product.

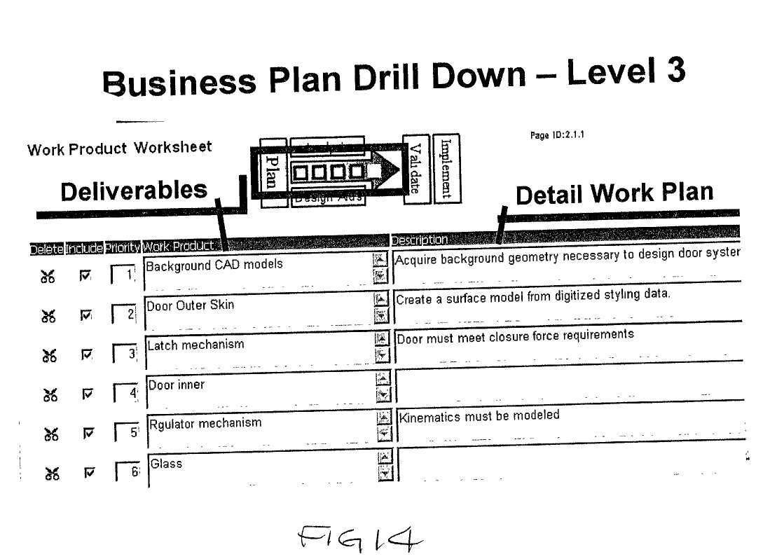

Finally, FIG. 15 displays a spreadsheet in a screen form which allows various budget, timing and resource information to be input for any of the work products shown in FIGS. 13 and 14.

Referring back to FIG. 2, with the estimate information provided in step 12 using any of the level 1, 2 and 3 spreadsheets described above, the REF is sent to management for a go or no-go decision in step 13. When approved, the RFE then is issued to the sales department for use in a quote package depicted in step 14.

It should be noted that the various estimated costs for design, engineering, labor, material, etc., for each product, whether at the entire product state, major subsystem stage, for subassemblies or for individual components, are used to form a bill of material for the product and its components as shown in FIG. 32.

The BOM module is a subset of the Estimating and Quoting module that allows the user to develop the BOM (Bill of Material) for each project. The BOM has indented features to show assemblies, sub-assemblies and components as seen in FIG. 32.

A critical part of the RFQ module is the estimating and quote module. This module facilitates the development of the response to an RFQ by electronically issuing the description of the opportunity, then tracks the response of each functional area responding to the RFQ to assure that the response is delivered electronically to the Estimator on time. It also provides methods to allow the piece cost, and tooling values to be developed as well as the engineering budget needed to execute the program. Once all the input has been received by Estimating, the process also provides a method for the Estimator to add profit mark-up and thereby develop the official response to the quote in terms of price, and tooling, as well as engineering budget allowed for execution of the project.

The RFQ process described above can be used in its entirety, or to provide a quick estimate or quote, to generate a bill of material (BOM) or merely to initiate a project by provide for the selection of team members and a definition of product requirement without requiring any product or manufacturing cost information.

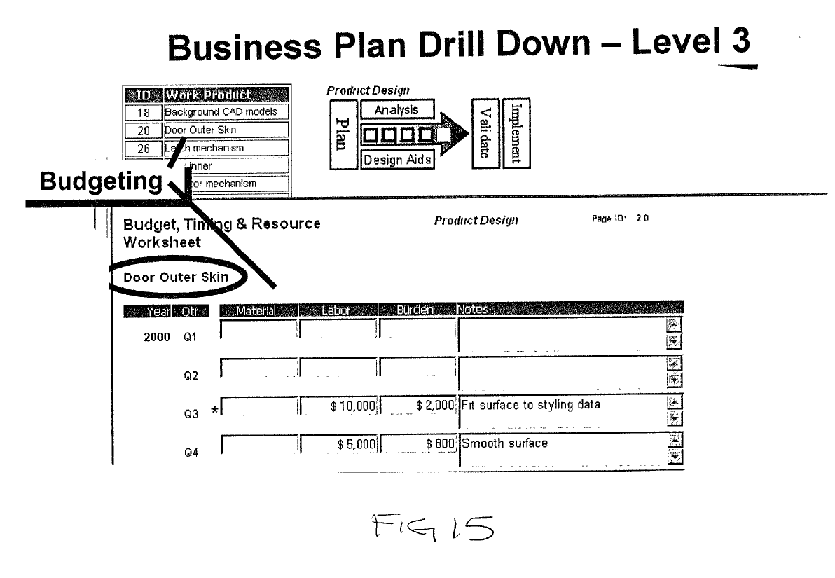

Referring now to FIG. 16, there is depicted the typical stages in the creation of a program plan and then the implementation of that plan to develop a product according to a product development process of the present invention.

As shown in FIG. 16, the development of the program plan 20 generally includes a number of steps including the development of a business strategy, a product description, a manufacturing system to develop the product, program management, supplier management, timing and scheduling of the product development, business and financial parameters, and technology transfer for use in developing the product.

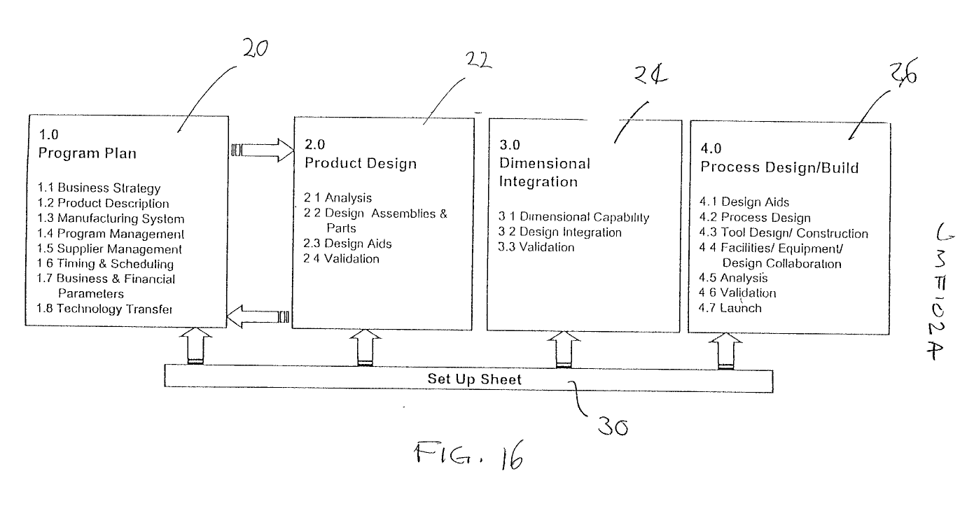

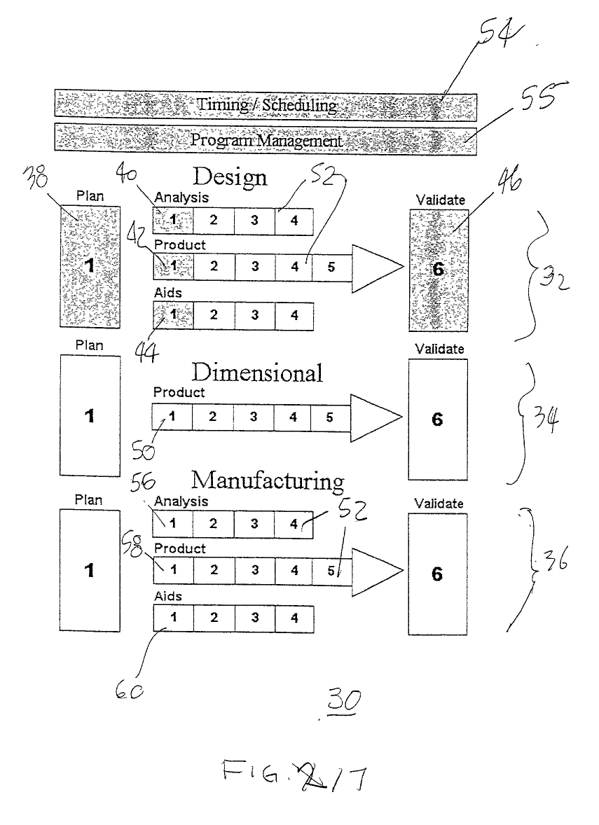

The development of the program plan as well as the implementation of the program plan as developed through separate product design 22, dimensional integration 24, and process design/build sections 26 is controlled by means of a unique set-up graphical interface or set-up sheet 30 shown generally in FIG. 16 and in greater detail in FIG. 17.

The graphical interface or set-up sheet 30 is generated by a software program stored in the memory of a computer or computer network. The computer network will generally allow access to the program from various terminals or nodes; while allowing inputs and outputs in the form of data, inquires, etc., as described in greater detail herein, to be made to the database defining the program set-up plan to be made from any of the terminals, assuming suitable access authorization requirements are met.

The set-up sheet 30 enables the user to add work products or objects which are the deliverables in a product development project. For example, if the project involves the building of a chair, one would need to design the chair and create a bill of material (BOM.), create the tooling to manufacture the chair, and do design analysis, such as finite element analysis (FEA), etc. The objects that need to be produced, namely, the drawing, the 3D model, the BOM, and the tooling are the deliverables for the project. Most of these work products or deliverables will not go to the end customer, but still must be created in order to get the chair developed, manufactured and shipped.

Each of these work products will have certain attributes associated with it. These attributes relate to financial information or cost and are entered into the appropriate area in the set-up sheet 30. Each work product will have resources or people needed to create the work product. Work products also have attributes of materials, labor and burden which are also entered into appropriate spaces in the set-up sheet 30.

Timing is another aspect of the work products. Large projects will be longer in duration, most likely requiring years for the product to be developed and manufactured. This means that the set-up sheet 30 must accommodate a long time frame defined in a timing/scheduling area 54 for entering work products, their attributes and the critical timing dates that must be met along the way.

The set-up sheet 30 also includes a project management area 55 which accommodates the resources needed and the costs associated with the management of the project.

Table B depicts the menu selections for the program set-up sheet 30. Upon entering this phase of the product development software, a user can access any menu stage to display more detailed information templates for review, data input, editing, etc.

As shown in FIG. 17, the set-up sheet 30 is a graphical interface including three arrow stages 32, 34 and 36, one for product design, one for dimensional management or integration and one for manufacturing, respectively. All of the areas within each arrowed stage 32, 34, and 36 include substantially identical sections, including a plan 38, analysis aids 40, work products 42, design aids 44, and validation 46. Each individual area or section on the graphical interface or set-up sheet 30 is individually selectable either by clicking on a specific box or section in the set-up sheet 30 or by calling up the main menu for the program set-up stage as shown in table A. Once selected, each area is replaced by a small pop-up window or screen which enables a user to enter specific work products and their corresponding resources and attributes as well as to view the work products, resources and attributes previously entered into a particular section 32, 34, and 36 of the set-up sheet 30. Editing and data entry authorization and access to view any stage or section is controlled by a project authorization protocol established in the program management section 55.

It should be noted that the dimensional management stage 34 includes only one arrowed section 50 for work products. This is due to the fact that the dimensional management stage 34 does not require any design or analysis aids.

The manufacturing stage 36 can be for the entire product or subdivided into individual arrowed sections, each having deliverables, aids and analysis for stages of the manufacturing design including process, tool and facilities/equipment. For products requiring complex manufacturing designs, the tools can be further subdivided into individual arrowed sections for various tool elements, such as molds, racks, secondaries, and fixtures.

Each sub-section for analysis aids, work product and design aids, such as sections 40, 42, and 44, are subdivided into individual time zones or cells denoted generally by reference number 52. These time cells 52, while arranged linearly and evenly across the set-up sheet 30, are designed to cover time periods ending in important or critical dates set in the timing/scheduling section 54 of the set-up sheet 30. These time periods can be equal or of different length

It should also be noted that the individual time cells 52 in each separate section 32, 34, and 36 are arranged to be co-extensive or simultaneous in a time wise fashion. This enables the dimensional management and manufacturing process design stages 34 and 36 to begin to be developed at an earlier time than in a typical product design process in which the manufacturing process required to manufacture the product is typically left to the end stages of the overall product development process.

The product design stages 32 includes analysis aids, product design work products and product design aids 40, 42, and 44, respectively. The manufacturing or process design stage 36 includes time cells for process design analysis aids 56, process design work products 58 and process design aids 60.

It should be noted that after completion of the validation section 46, etc., for each of the product design, dimensional management and manufacturing design stages 32, 34, and 36 respectively, product development control advances according to the arrows shown in FIG. 16 to the implementation stage of the product design section 22, the dimensional integration section 24, and the process design/build section 26.

As noted above, each of the individual sections of each of the three arrowed stages 32, 34, and 36 of the set-up sheet 30 are individually selectable through the graphical interface by means of clicking on any section, such as the plan 38, the design analysis 40, design product 42, design aids 44 and design validate sections 46.

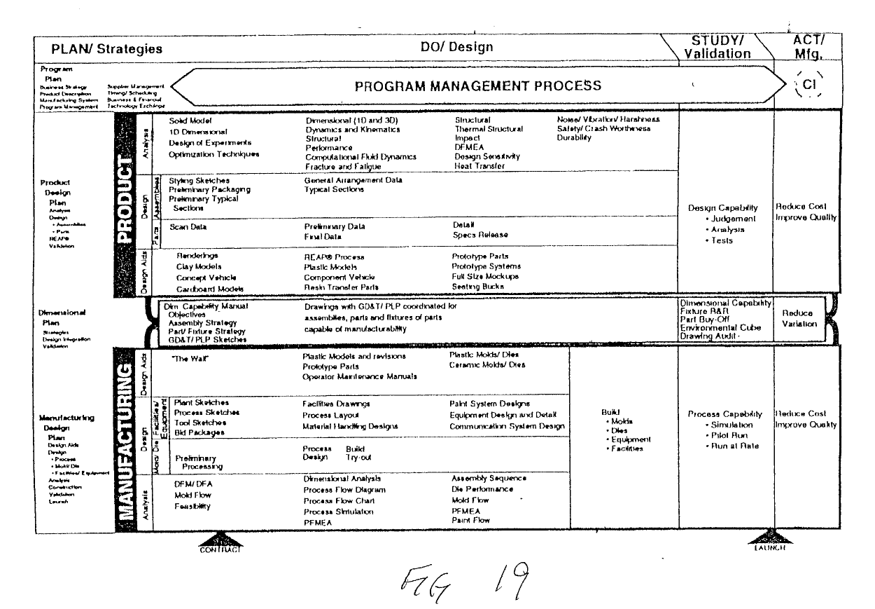

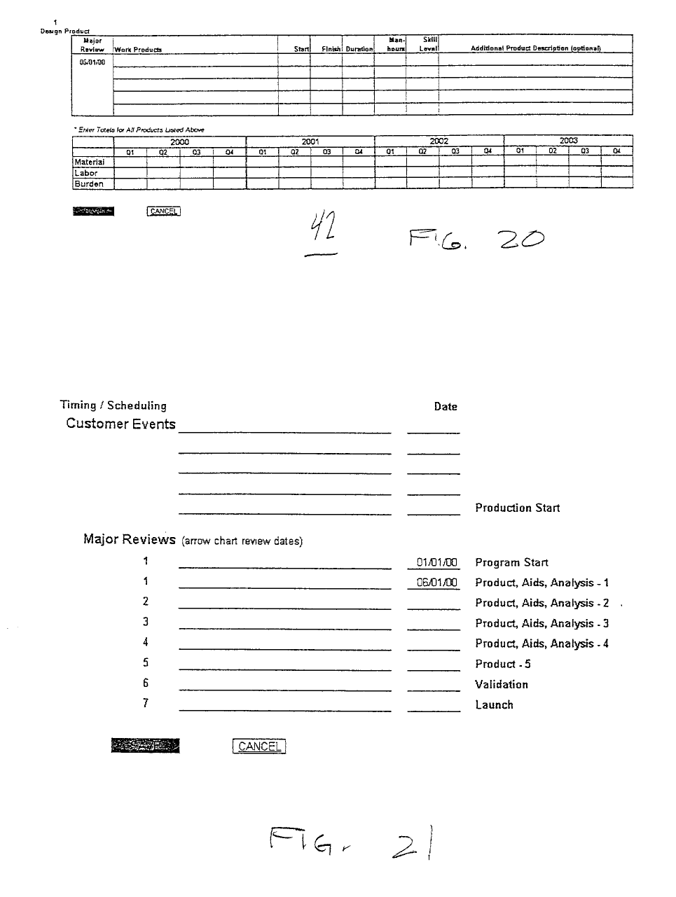

Once one of the sections is selected by a click, a small pop-up window, such as the pop-up window or screen shown in FIG. 20, will be displayed on the graphical interface, as indicated for design work product section 42. A chart is displayed on the graphical interface for the first time zone labeled number sign “one” which displays its review date. The chart allows the user to enter the specific work product as well as the resources or people needed to create the work product. The attributes of the work products in the form of material, labor and burden can also be entered into the lower section of the chart shown in FIG. 20.

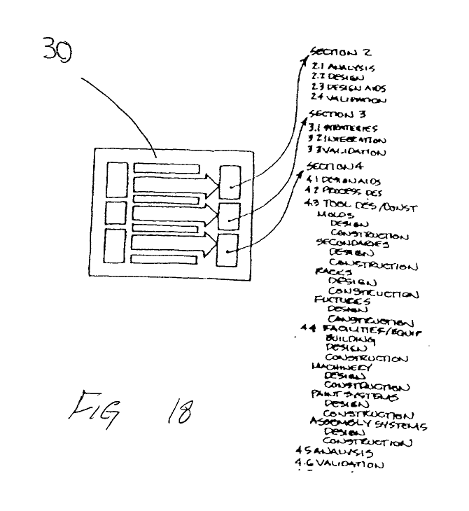

Referring back to FIG. 19, there is depicted an example of a completed product set-up sheet 30 which contains work products, analysis aids and design aids for the design stage 32, the dimensional management stage 34 and the manufacturing stage 36. The parallel arrangement of the design, dimensional and manufacturing stages 32, 34 and 36 provide for concurrent work to take place in each of these areas. This shortens the overall product development process as compared to the typical sequential flow of a product development from design, through dimensional analysis and then the development of the manufacturing process and tools to build the product. Changes made in any one of the design, dimensional and manufacturing stages are immediately available to other team members to allow coordination and implementation of any change effects on other aspects of the product development.

The benefits of the graphical interface or development model of the set-up sheet 30 of the present invention are many. The graphical interface allows a user to easily see what has been entered and what is yet to be entered. The graphical interface allows all three areas (product, dimensional and manufacturing) to collaborate easily. Any user can see what all other groups are doing and how all of the work products and information for the entire project are fitting together. This overall view facilitates even greater collaboration between the various groups.

The graphical interface also enables any user to enter data in any order they choose. One user may know most of the information for a particular area, but may need to come back to certain sections after thinking some more or obtaining additional information. This way of entering the data allows a user to easily edit without having to walk through the entire data entry process again. Any user can just click on a time zone or a work product and put the needed information into set-up sheet 30.

Also, every user can look at all of the stages on the program set-up sheet 30; but only the people responsible for the different areas can enter or update data. The responsible persons name is on the entry panels for his or her section. This gives the other users easy access to who is responsible for each area and an easy way to contact them by e-mail or other communication means.

The program set-up sheet 30 is a work in progress until there is a final sign-off by the timing and scheduling person, the product design manager, the dimensional manager and the manufacturing manager. Once everything has been entered and balanced, all of the areas can sign off on the program set-up sheet 30. The program set-up sheet 30 then becomes the information to work into the implementation stage of the project.

Clicking on the time/scheduling bar 54 in FIG. 17 causes a pop-up window or screen shown in 56 to be generated on the graphical interface. Various entries can be provided for customer events and the date specified by the customer as well as major review dates for each of the individual time zones 52 in the design, dimensional, manufacturing section 32, 34, and 36. A timing and scheduling person controls the critical events and major due dates for the work products.

The product design manager, the dimensional manager, and the manufacturing manager fill out their respective areas of the program set-up sheet in parallel rather than sequentially. Each person can see the progress made by the other managers.

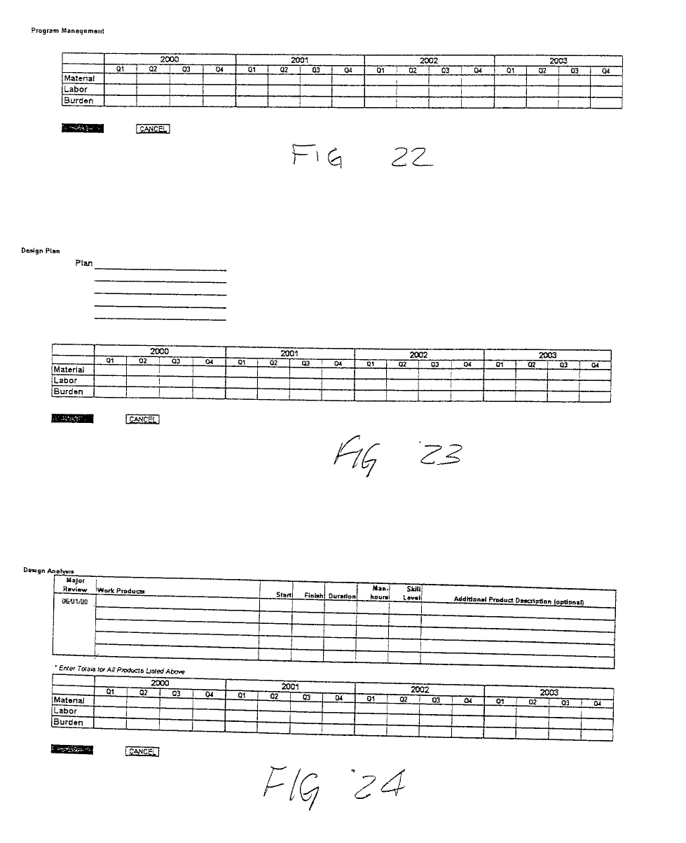

Clicking or selecting the program management section 55, see FIG. 17, causes a pop-up window or chart shown in FIG. 22 to be generated on the graphical interface 30. This screen contains a number of entry fields. Financial information is entered for each quarter of each year of the project. Default for the program set-up sheet 30 is a four-year project duration.

A resource field is a numeric integer field that denotes manpower in terms of the number of workers, which are needed to manage this job during the specified time zone or for the specified dates.

The materials field is a currency field that denotes the material costs, including contract labor, needed for project management for the particular time frame or zone selected. The labor field is a currency field that denotes the cost of labor for the resources specified in the resource/manpower field. The burden field is a currency field that denotes the cost of extras associated with project management in a particular time zone. This may include facilities, benefits, or other expenses that are not already included in the material or labor financial numbers.

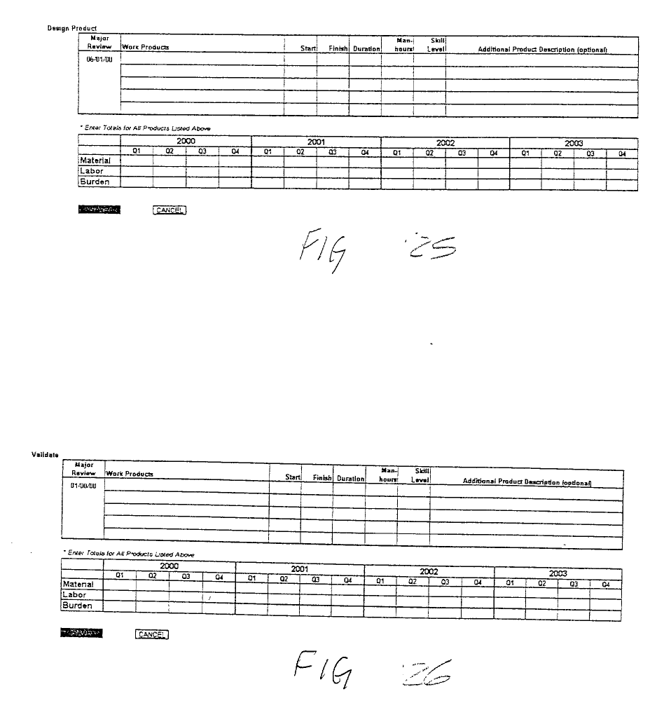

Referring now to stage 32, the product design stage 32 of a complete program set-up sheet or interface 30 defines the resources needed and the work products to be delivered for the product design phase of the entire product development process. This section 32 includes a plan section 38 which, when selected, causes a pop-up window to be generated on the graphical interface 30 allowing the user to enter the planned cost and resource information associated with the product design management as shown in FIG. 23.

When any time zone in the time zone 52 of the design analysis section 40 is selected, a user may enter specific analysis aids that are needed in conjunction with the creation of the work product in the same time zone.

The analysis aids text list field allows the user to enter up to four analysis aids that are created to support the work product in the same time zone. These aids may be analysis tools like finite element analysis programs for specific CAD package offerings that need to be used. The resources/manpower field is a numeric integer field that denotes manpower in terms of the number of workers needed for analysis work during the specified time zone or by the specified dates.

The material field is a currency field that denotes the material cost for the analysis aids for the particular time frame or zone selected. This is financial information that is used to calculate the cost of creating or producing the work products. The labor field is a currency field that denotes the cost of labor for the resources specified in the resource/manpower field. Finally, the burden field is a currency field that denotes the additional costs of creating an analysis aid during a particular time zone.

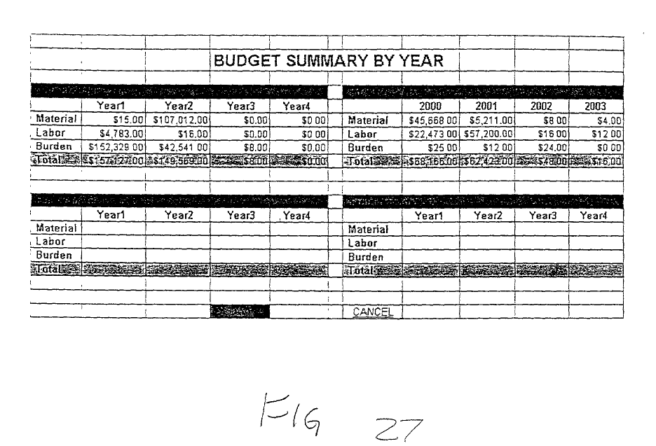

Clicking on any time zone 50 in the design aid section 44 will cause a pop-up window to be generated similar to that shown in FIG. 24. However, instead of analysis aids, the user may enter design aids needed to support the creation of the work products in the same time zone. Up to four design aids may be entered in the text list field to support the creation of the work products in the same time zone. The resources/manpower, materials, labor and burden serve similar functions as in the design analysis aid section described above and shown in FIG. 24.

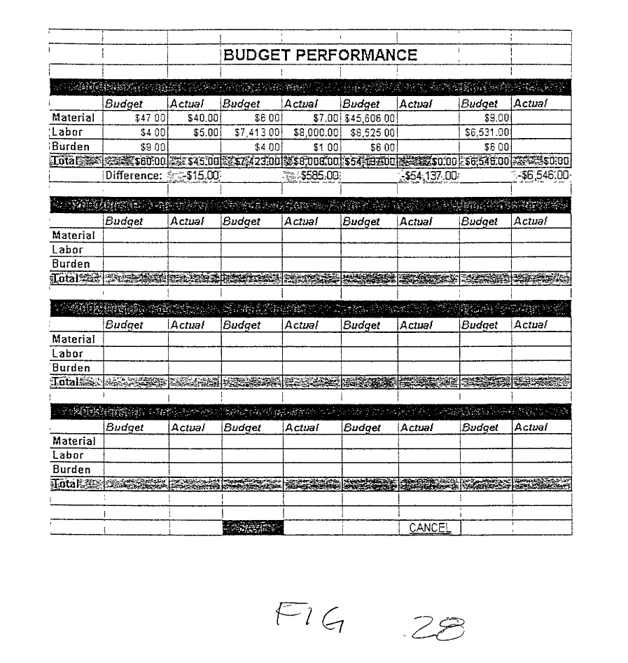

When the design work product section 42 is selected, the user may enter specific work products that are the deliverables that must be produced at each stage of the project. When a work product area in a certain time zone is selected in the design stage 32, a pop-up window is generated which allows the user to enter a work product text list field containing spaces for up to four work products per time zone. These products may be for internal use and never given to the customer, yet they are vitally important to completing the project. Examples of such work products may be a CAD drawing, or a prototype of the final object to be manufactured. The resources/manpower, materials, labor and burden sections of FIG. 25 are similar to the corresponding sections in the analysis aid and design aid sections 40 and 42.

In the dimensional management stage 34, only a work product section 50 is provided. A work product text list field is generated which allows a user to enter up to four work products per time zone, such as CAD drawings, a prototype of the final object to be manufactured, etc. Resources, materials, labor and burden sections may also be provided as described above for the design and manufacturing stages 32 and 36.

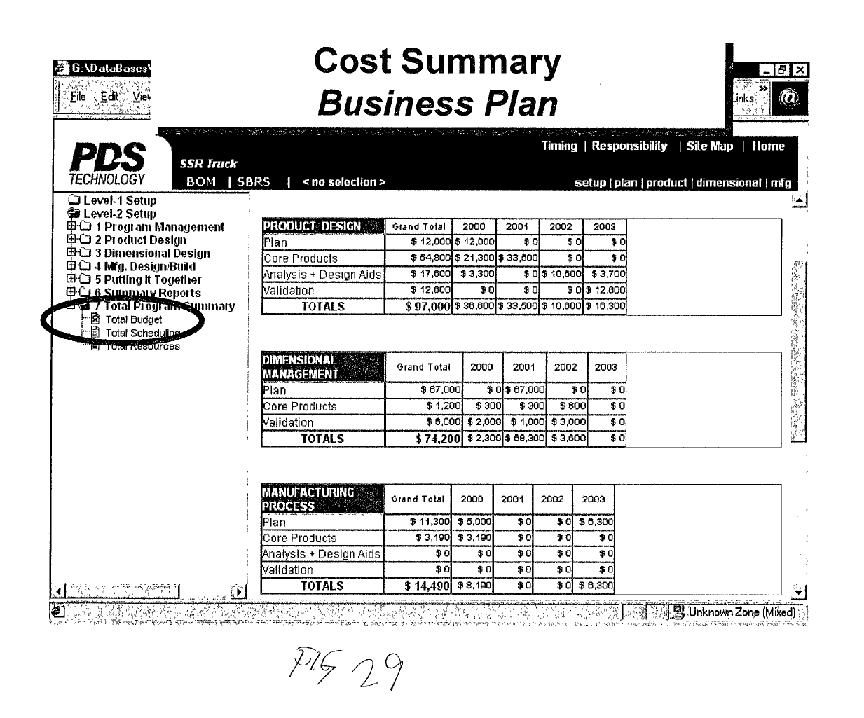

Clicking on the validation section of the dimensional management stage 36 allows the user to enter validation information through a pop-up window in terms of resources and work products. The user enters the work products or description for the validation process and then the attributes of the materials, labor and burdens associated with the validation process as shown in FIG. 26.

Selecting any time zone 52 in the product manufacturing stage 36 or manufacturing analysis aids 56, manufacturing work products 58 or manufacturing design aids 60 sections generates similar pop-up windows to that described above and shown in FIGS. 22-26. When the time zones 52 in the work product stage 58 are selected, the user can enter up to four work products into a text list field. These can include a tooling CAD drawing or a prototype of a final object to be manufactured. The resources/manpower, materials, labor and burden sections are similar to that described above. The analysis aid and design aid sections 56 and 60 of the manufacturing stage 36 are also similar to that described above for the analysis aid section 40, the design aid section 44 and the design stage 32.

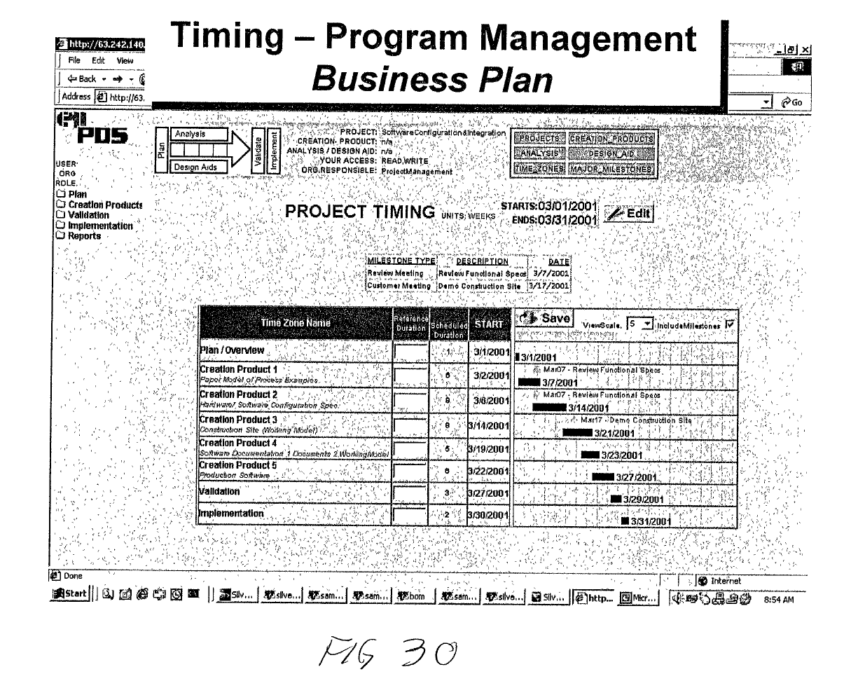

FIGS. 27 and 28 depict output displays in the program set-up sheet 30. By example only, FIGS. 27 and 28 depict the two major summary reports for the financial information in the set-up sheet 30. These include a summary of the project management, product design, dimensional management and manufacturing stages by year, and by quarter for material, labor and burden.

FIG. 27 depicts the budget summary by year of all the material costs for all of the work product, design aids, analysis aids, the plan and the validation for product design and sums these costs to produce a first year material cost for the product design. The same process is repeated for the labor and burden costs for the product design. This whole process is repeated for the manufacturing stage 36.

The dimensional management section 34 is calculated a bit differently.

As there are no analysis aids or design aids for dimensional management, the material, labor and burden for the plan, work products and validation are summed independently in the lower portion of the same summary chart shown in FIG. 12.

FIG. 28 depicts the yearly summary of material, labor and burden broken down by quarter. The quarterly summary of material costs for the first year of the project are calculated. Specifically, the material costs for the first quarter of the first year of all of the work products, the plans, the validation sections, the design aids, and the analysis aids are calculated and put into the summary chart in the year one, first quarter section. The same process is repeated for the remaining quarters and the remaining years of the product development schedule.

The program set-up sheet 30 has security and access levels which allow only certain authorized users to edit and/or enter information into the various screens in the program set-up sheet. At least five main individuals are responsible for entering data into the program set-up sheet 30.

However, it will be understood that any user who has general access to view any part of the program set-up sheet, can click on and call up a screen or any part of the program set-up sheet 30 to view the contents. This enables users working on various aspects of the product development process to view the work product and activities of other users working on the project to determine their progress, whether or not certain information has been provided by these other individuals for use by another individual, etc. This process also enhances collaboration between the various users with the end result being a shortened product development time frame.

The program set-up sheet 30 can be used in two different ways, namely, in a sequential sequence or in a random, independently accessible sequence.

The program set-up sheet 30 can step a user through a structured input process that follows a theory of thinking in a process on how to create the work products, supporting data and the financial information in a collaborative environment. Each stage, namely, the product design, the dimensional management and the manufacturing stages 32, 34, and 36 only work together to balance the work load.

The structured process would require the user to enter the plan first. The user would then enter the work products for all the time zones before entering the validation for the work product. Lastly, the aids would be entered. This process would be the same for all three stages 32, 34 and 36, namely, product design, dimensional management, and manufacturing. Once all the work products have been entered, the individuals responsible for the three areas would get together to balance the work. Once the work load was balanced, the financial information would be entered.

The program set-up sheet 30 works in this sequential manner by using the “next” button on the bottom of the screen. The user can start with a plan in whatever section they are responsible for and by hitting the “next” button, they will be stepped into the first work product box. If the user hits “next” again, he or she will be stepped into the second work product box. This will continue until the user has finished entering all of the aids. Once all the work products have been entered along with the supporting data, the same process can be followed for the financial information.

The program set-up sheet 30 also allows a user to enter the program set-up process at any place along the process. The user can select any box or section and enter data into it. This does not mean that the user will not follow the above sequential thinking, but if a user has more information at a certain time, he or she can enter it instead of walking through a sequential process to get to the exact point in the process in which they need to enter such data.

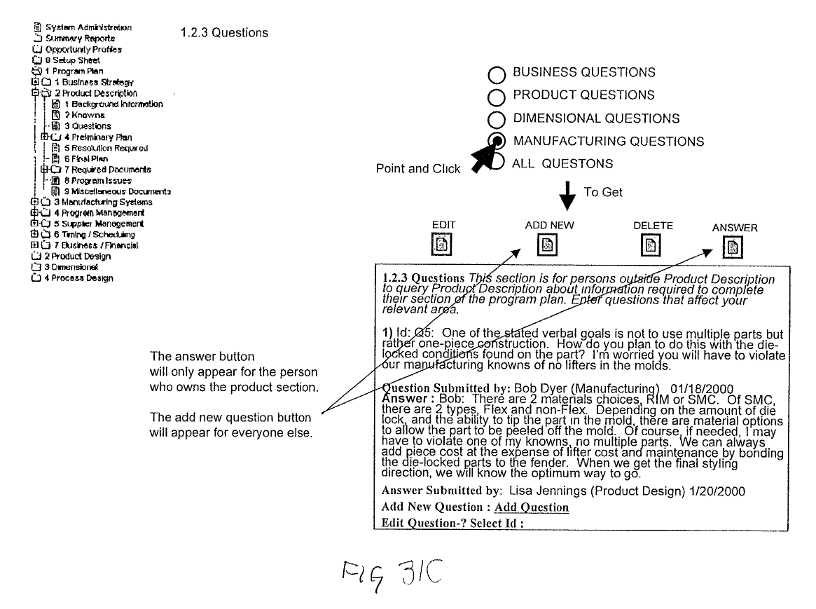

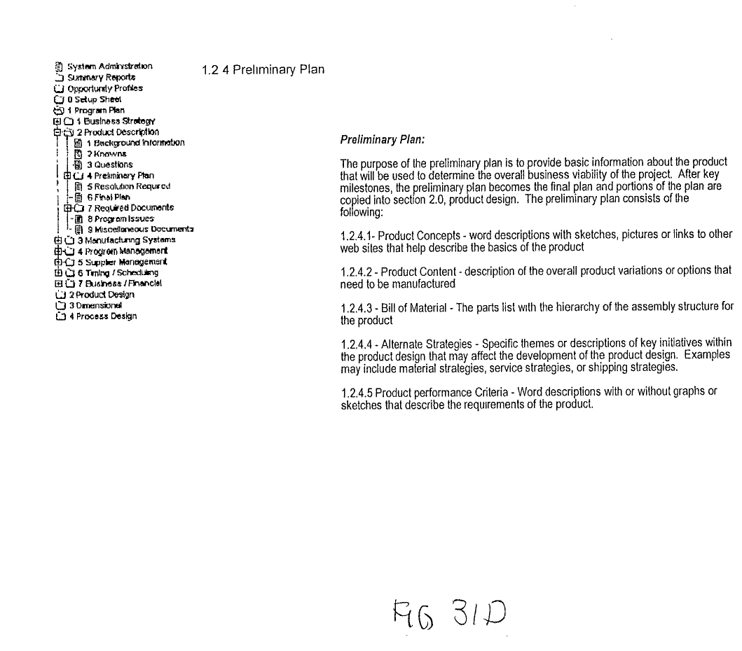

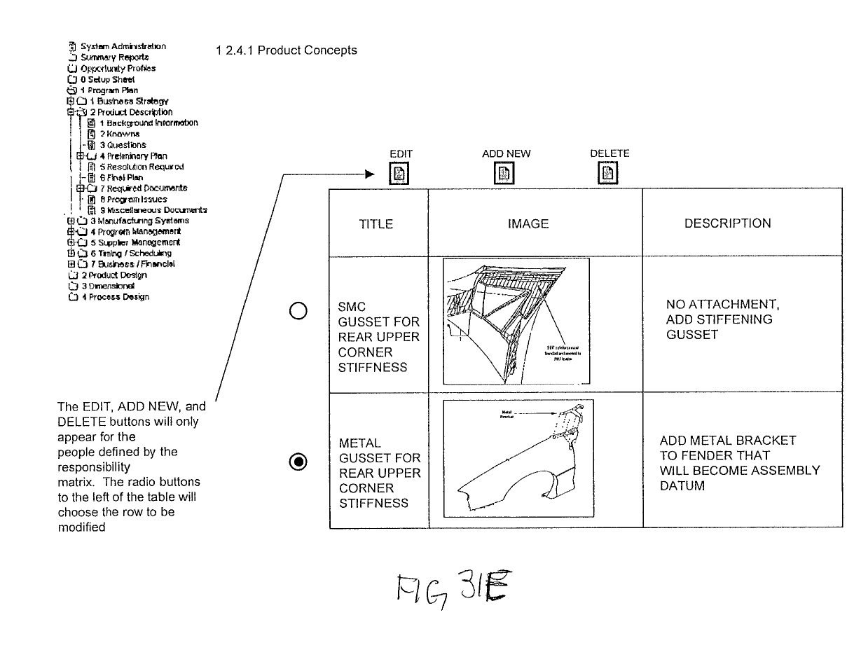

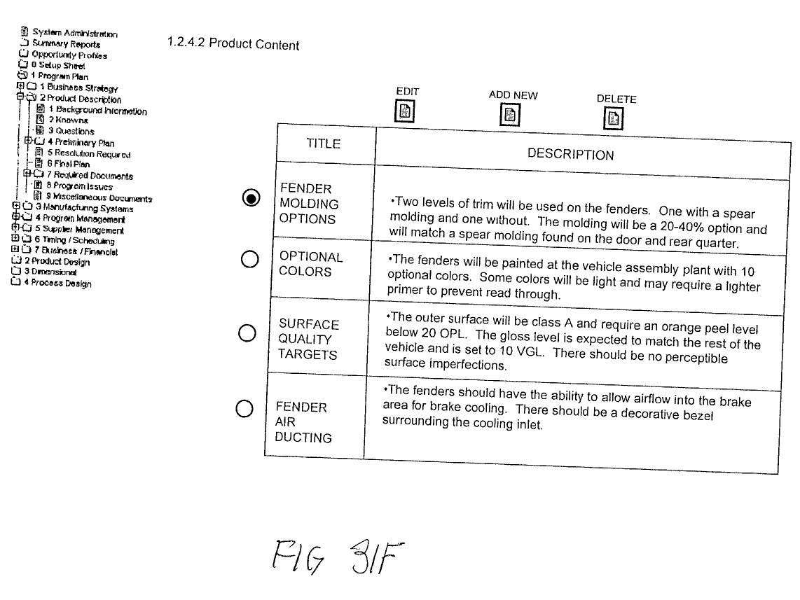

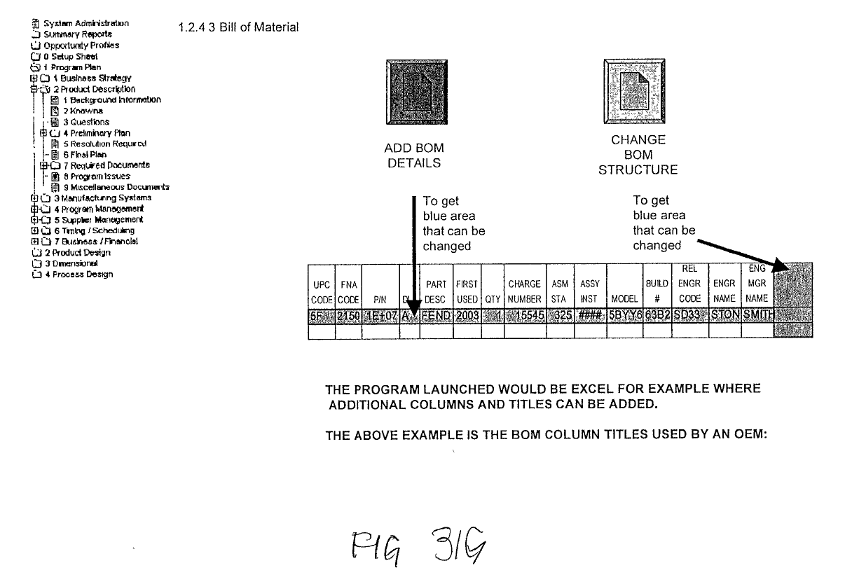

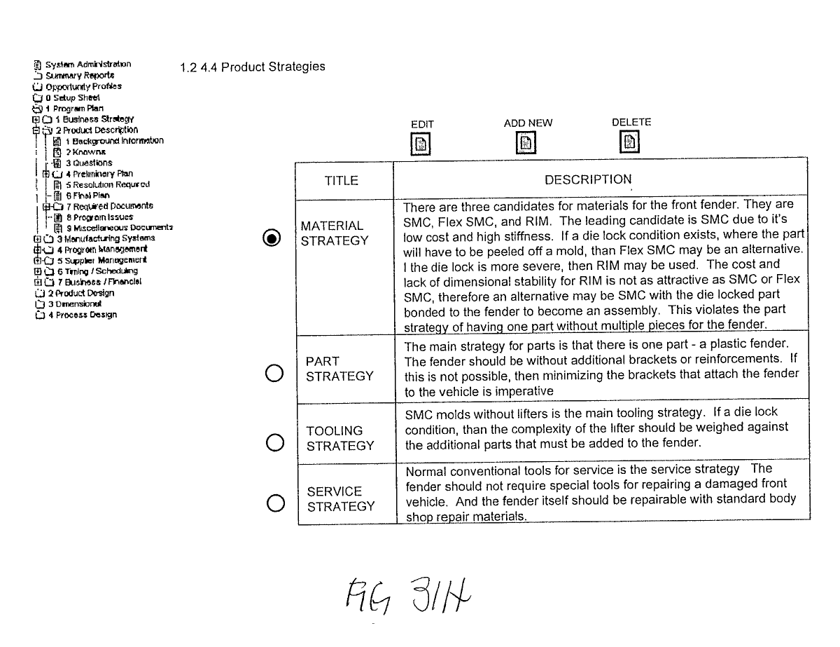

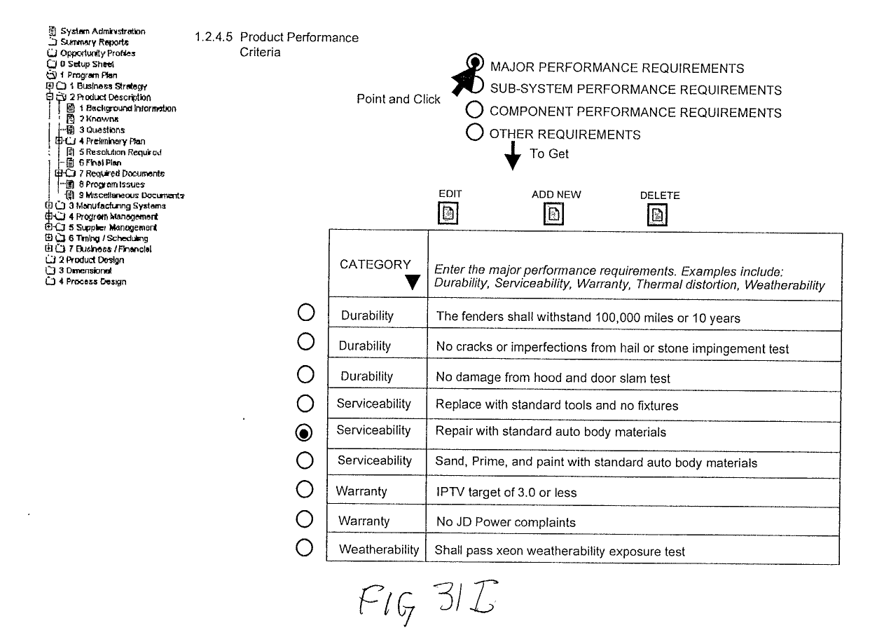

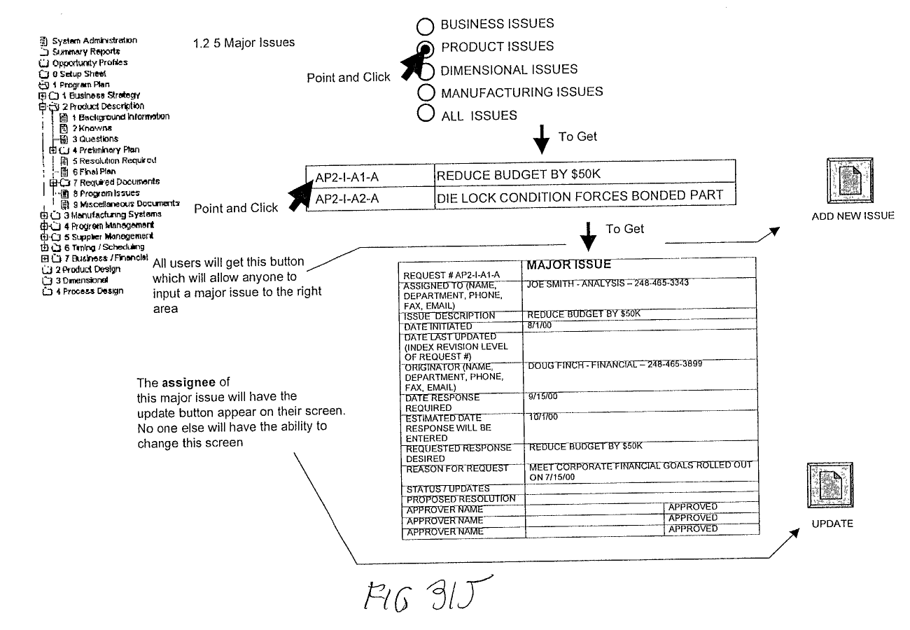

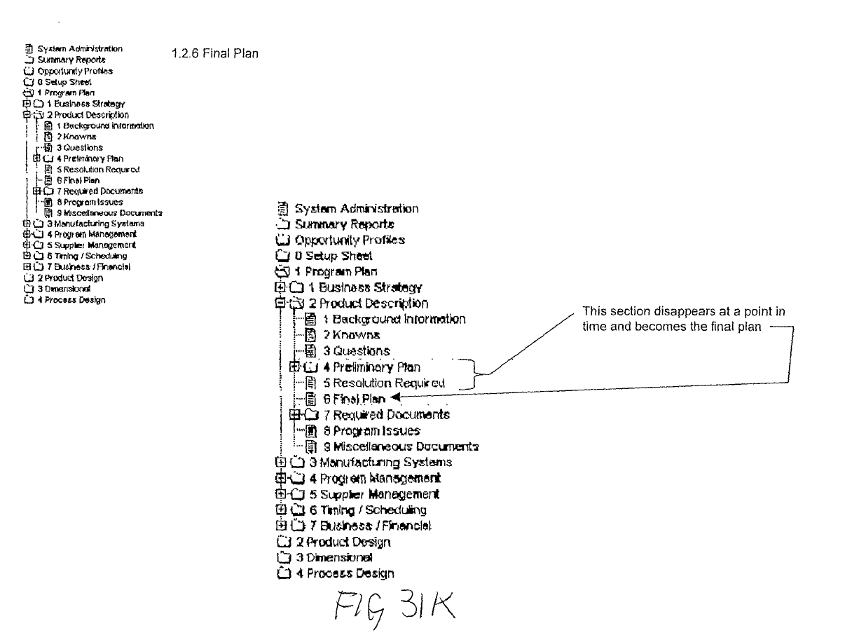

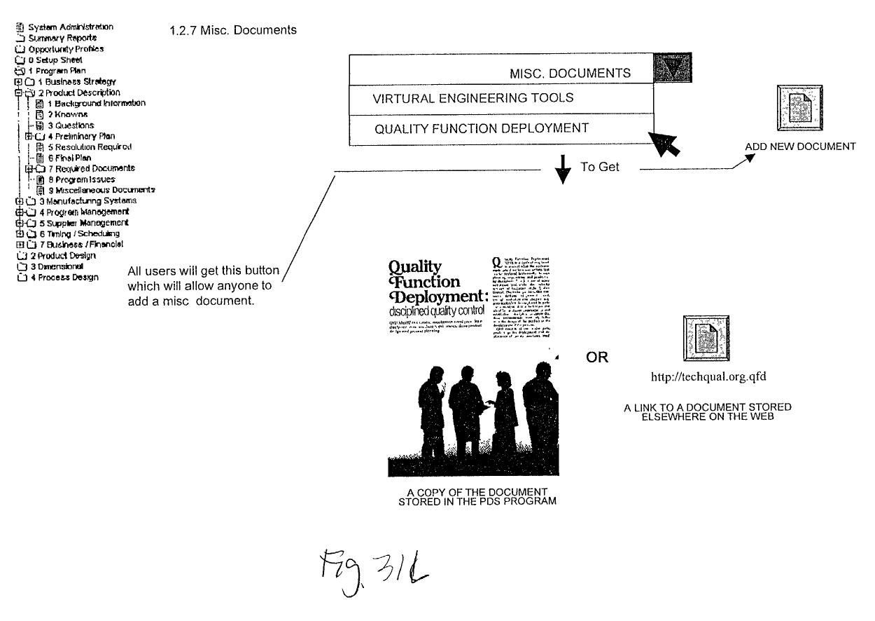

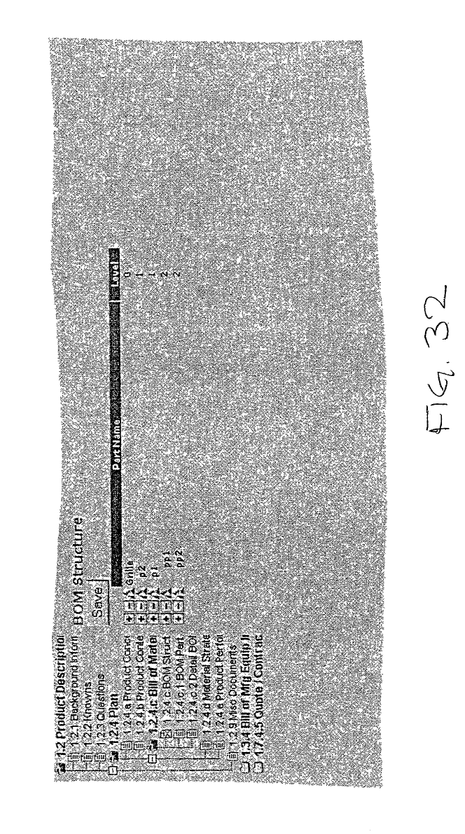

The multiple pages of Table C depict the master menu for the program plan 20 shown in FIG. 16. The program plan master menu provides selection of successive screen templates, aa portion of which are shown in FIGS. 31A-31L, which allow data entry in the product description phase of the program plan 20. These successive screens provide areas for user input to define all aspects of the product description in as much detail as desired or necessary. Once the program plan 20 has been developed, the arrowed stages 40, 42, and 44 of each of the design, dimensional and manufacturing sections shown in FIG. 17 are used in the set-up sheet program 30 to reach a validation of each phase of the program plan.

Once validated, the program plan 20 can be input for management approval. When approved, the program plan 20 generates the background information required for the user to present the program plan to the customer. Subsequent changes, based on customer feedback, can be reprocessed through the set-up sheet 30 and the program plan 20 as described above until the customer agrees to the proposed plan 20. The plan 20 then becomes the implementation plan and the measurement tool for the implementation stages of product design 22, dimensional integration 24 and process design/build 26.

In each stage, such as the product design stage 22, various screens are generated which allows a user to implement the various stages of the product design implementation phase of the present invention. At the same time, working through the set-up sheet 30, the user can implement the dimensional integration stage 24.

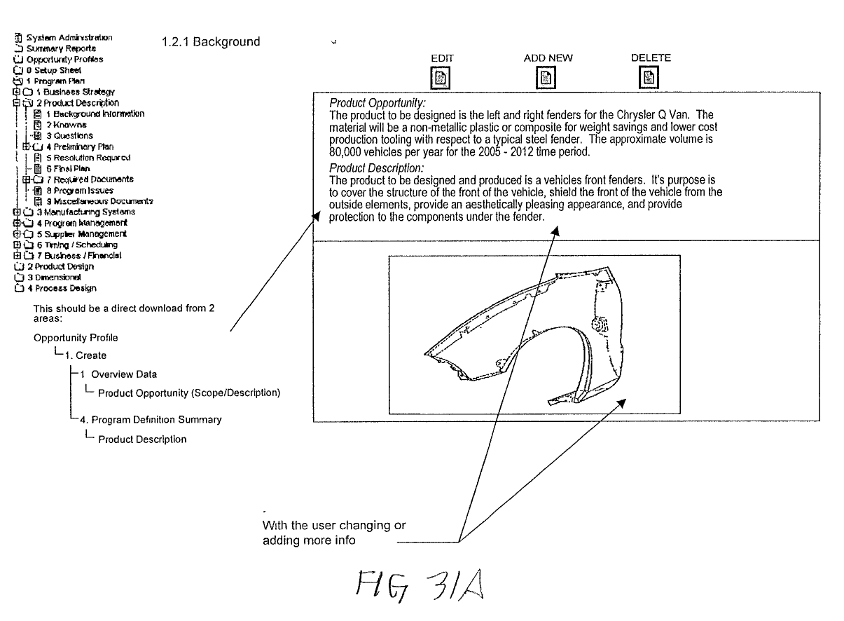

FIG. 29 depicts a cost summary spreadsheet which can be used to summarize, on a periodic basis, the cost for each of the phases in the product development, including product design, dimensional management and manufacturing process.

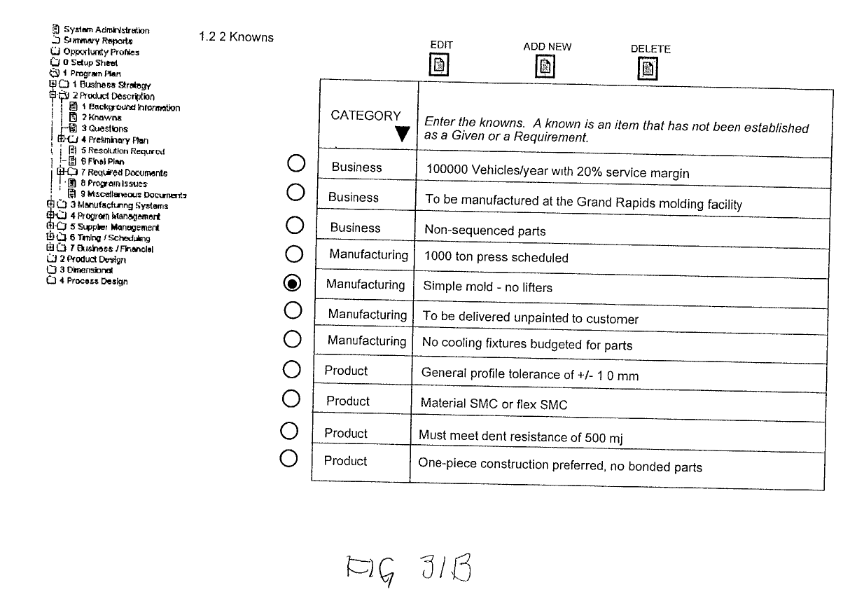

FIG. 30 depicts an example of a spreadsheet used to implement the time-scheduling section 54 of the set-up sheet 30. All of the products, which can constitute components of a single larger product or subassembly, are listed along with start dates, process duration, etc.

Once the contract for the development and manufacture of a particular product as covered by a particular RFE has been awarded to the company, the original plan used to form the RFE along with any revisions or modifications that were required to obtain the business becomes the final business plan or program plan 20 as described.

Other aspects of the product development process will now be described.

The APQP (Advanced Product Quality Process) Module is a subset of the RASIC (Responsible-Approval-Support-Inform-Consult) Module that is used to track completion of each APQP item. It provides an APQP completion status for each project at any time requested. For all DCX projects, the module also provides an alert to the Powerway Administrator(s) as each APQP item is completed so that Powerway can then be updated.

The RASIC Module is the Program Management Module. It allows a company to develop a master list each of the steps in their product development process in chronological order and also assigned to the R,A,S,I, and C person to each step. R is the Responsible person, A is the Approver person, S is the Support Person, I is the Inform person, and C is the Consulting person. The completion date for each step is defined and the critical path for program execution is defined. At the outset of a project, the Program Manager is assisted by the system to develop a program specific RASIC chart representing only those steps appropriate for that program. The Functional Managers then assign people from their organizations into the R,A,S,I, and C steps. The R person is then responsible to complete the steps they have been assigned. They are required to mark each step as being either green, yellow, or red on a continuing basis representing whether they assess on time completion (green), step may not be completed on time (yellow) or step will not be completed on time (red). Therefore, the RASIC process, automated and reported on by the software is the method that allows each team member to know when each task is due, to report to management of any potentially late tasks so that appropriate action can be initiated to get back on track. It is also a tool that can be used by management to level workload within his/her department.

There are eight status reports for program status (timing, issues, etc.). They are the Issues Report, Open Issues Report, Measurements Report, Launch Report, Stoplight Report, Financial Report, Gate Review and Dates Report, and Percent Scrap Report. The Events Report is broken down into 3 sub reports: Red items, List RASIC items due for a specified time interval, and List % Yellow, % Green. The Measurement Report is broken down into 3 separate reports: Programs that started Phase 2 Exit Mold Run, Programs that started Phase 3 Exit Mold Run, and Programs that exited Phase 3. In total, there are 12 separate reports available.

The Lessons Learned module allows anyone to enter a potential Lessons Learned item into the system. From there, the system utilizes the problem resolution process to define root cause, immediate corrective action, final corrective action, and irreversible corrective action for the issue. All Lessons Learned items are put into the Lessons Learned database, available for searches at Design Reviews, Gate Reviews to aid in not making the same mistake on future programs. Once irreversible corrective action has been implemented, the Lessons Learned item is removed from the Lessons Learned Database since the process or procedure has been revised to prevent recurrence of the issue.

All Gate Reviews (Team and Matrix) as shown in line items on the Lacks RASIC chart, designated as either T1, T2 . . . Tn for Team Gate Meetings or F1, F2 . . . Fn for functional Gate meetings. There are 8 Team Gate Meetings, and 10 Functional Gate meetings. The Team Gate meetings precede the Functional Gate meetings, with the goal being to make sure the team is ready for the Functional Gate meeting where management reviews readiness to proceed. As each Functional Gate review occurs, electronic sign-off by each Functional Manager is obtained. Open issues are documented and followed-up on until each Gate is exited. Multiple attempts to pass a gate will be recorded by the software.

Thus, there has been disclosed a unique process for developing a product using a program set-up sheet in the form of a graphical interface on a computer system having a display. The process includes the steps of displaying in a time-wise fashion separate time-based product design, dimensional management and manufacturing stages of the product development process; providing product design, dimensional management and manufacturing plans; and defining a step of time, space and requirements for each section of the product design, dimension, management, and manufacturing stages to advance to the next time-based stage.

The process further includes the step of providing for any of the product design, dimensional management and manufacturing stages at least one of analysis aids, design aids, and work products to support the product development requirements of each stage.

The process also includes security access allowing only authorized individuals to access and enter and edit data in any one of the product design, dimensional management and manufacturing stages.

TABLE A
Menu for Section 000.0
Home Page (My Work Area)

000.0 My Work Queue

000.0.1 RFE

000.0.1.1 Drafts
000.0.1.2 Sent
000.0.1.3 FY Approval
000.0.1.4 FY Estimate
000.0.1.5 FY Information
000.0.1.6 FY Revision
000.0.1.7 FY Pricing
000.0.1.8 FY Quote

000.0.2 Projects
000.0.3 Reminders
000.0.4 Alerts

000.1 Status

000.1.1 RFE
000.1.2 Projects

000.2 Follow-up

000.2.1 Answered
000.2.2 Un-Answered

000.3 Administration

000.3.1 Users
000.3.2 Roles
000.3.3 User-Roles
000.3.4 RFE-Roles

000.4 Delete Tables

000.4.1 Delete Data

Menu for Section 00.0
(Request for Quote Section)

00.0 Internal Request for Estimate Details

00.0.1 Document Information
00.0.2 Product Description
00.0.3 Annual Volume
00.0.4 Application
00.0.5 Quotation Preparation Data
00.0.6 Estimate Requirements

00.1 Program Definition Summary

00.1.1 Business Strategy
00.1.2 Product Description
00.1.3 Manufacturing Systems
00.1.4 Program Management
00.1.5 Supplier Management
00.1.6 Timing & Scheduling
00.1.7 Business / Financial
00.1.8 Technology Transfer

00.2 Approval / Decision

00.2.1 Quick Estimate

00.2.1.1 Administration Sheets
00.2.1.2 Estimate Sheets

00.2.1.2.1 Piece Cost
00.2.1.2.2 Tooling

00.2.1.3 Pricing Sheets
00.2.1.4 Customer Agreement
00.2.1.5 Administration Sheets
00.2.1.6 Notification

00.2.2 Detailed Estimate

00.2.2.1 Administration Sheets
00.2.2.2 Notification
00.2.2.3 Proceed to Section 1.1

TABLE B
Menu for Section 0.0
(Program Setup)

0.0 Program Setup

0.1 Program Management

0.1.1 Plan

0.1.1.1 Lessons Learned Review
0.1.1.2 Definition - Requirements and Brainstorming

items 1 through x

0.1.1.3 Budget
0.1.1.4 Timing
0.1.1.5 Summary

0.1.2 Creation Products

0.1.2.1 Definition - Creation Products 1 through 5
0.1.2.2 Budget - Creation Products 1 through 5
0.1.2.3 Timing
0.1.2.4 Summary

0.1.3 Validation

0.1.3.1 Definition items 1 through y
0.1.3.2 Budget
0.1.3.3 Timing
0.1.3.4 Summary

0.1.4 Summary

0.1.4.1 Overall Budget
0.1.4.2 ICON Page
0.1.4.3 Detailed Cost
0.1.4.4 Timing

0.2 Product Design

0.2.1 Plan

0.2.1.1 Lessons Learned Review
0.2.1.2 Definition - Requirements and Brainstorming

items 1 through x

0.2.1.3 Budget
0.2.1.4 Timing
0.2.1.5 Summary

0.2.2 Creation Products

0.2.2.1 Definition - Creation Products 1 through 5
0.2.2.2 Budget - Creation Products 1 through 5
0.2.2.3 Timing
0.2.2.4 Summary

0.2.3 Analysis

0.2.3.1 Creation Product 1

0.2.3.1.1 Definition - Analysis Item 1 - Lessons

Learned

0.2.3.1.1.1 Budget

0.2.3.1.2 Definition - Analysis Item 2

0.2.3.1.2.1 Budget

0.2.3.1.3 Definition - Analysis Item 3

0.2.3.1.3.1 Budget

0.2.3.2 Creation Product 2

0.2.3.2.1 Definition - Analysis Item 1 - Lessons

Learned

0.2.3.2.1.1 Budget

0.2.3.2.2 Definition - Analysis Item 2

0.2.3.2.2.1 Budget

0.2.3.2.3 Definition - Analysis Item 3

0.2.3.2.3.1 Budget

0.2.3.3 Creation Product 3

0.2.3.3.1 Definition - Analysis Item 1 - Lessons

Learned

0.2.3.3.1.1 Budget

0.2.3.3.2 Definition - Analysis Item 2

0.2.3.3.2.1 Budget

0.2.3.3.3 Definition - Analysis Item 3

0.2.3.3.3.1 Budget

0.2.3.4 Creation Product 4

0.2.3.4.1 Definition - Analysis Item 1 - Lessons

Learned

0.2.3.4.1.1 Budget

0.2.3.4.2 Definition - Analysis Item 2

0.2.3.4.2.1 Budget

0.2.3.4.3 Definition - Analysis Item 3

0.2.3.4.3.1 Budget

0.2.3.5 Timing
0.2.3.6 Summary

0.2.4 Design Aids

0.2.4.1 Creation Product 1

0.2.4.1.1 Definition - Design Aid Item 1

0.2.4.1.1.1 Budget

0.2.4.1.2 Definition - Design Aid Item 2

0.2.4.1.2.1 Budget

0.2.4.1.3 Definition - Design Aid Item 3

0.2.4.1.3.1 Budget

0.2.4.2 Creation Product 2

0.2.4.2.1 Definition - Design Aid Item 1

0.2.4.2.1.1 Budget

0.2.4.2.2 Definition - Design Aid Item 2

0.2.4.2.2.1 Budget

0.2.4.2.3 Definition - Design Aid Item 3

0.2.4.2.3.1 Budget

0.2.4.3 Creation Product 3

0.2.4.3.1 Definition - Design Aid Item 1

0.2.4.3.1.1 Budget

0.2.4.3.2 Definition - Design Aid Item 2

0.2.4.3.2.1 Budget

0.2.4.3.3 Definition - Design Aid Item 3

0.2.4.3.3.1 Budget

0.2.4.4 Creation Product 4

0.2.4.4.1 Definition - Design Aid Item 1

0.2.4.4.1.1 Budget

0.2.4.4.2 Definition - Design Aid Item 2

0.2.4.4.2.1 Budget

0.2.4.4.3 Definition - Design Aid Item 3

0.2.4.4.3.1 Budget

0.2.4.5 Timing
0.2.4.6 Summary

0.2.5 Validation

0.2.5.1 Definition items 1 through y
0.2.5.2 Budget
0.2.5.3 Timing
0.2.5.4 Summary

0.2.6 Reports

0.2.6.1 Overall Budget
0.2.6.2 ICON Page
0.2.6.3 Detailed Cost
0.2.6.4 Timing

0.3 Dimensional Design

0.3.1 Plan

0.3.1.1 Lessons Learned Review
0.3.1.2 Definition - Requirements and Brainstorming

items 1 through x

0.3.1.3 Budget
0.3.1.4 Timing
0.3.1.5 Summary

0.3.2 Creation Products

0.3.2.1 Definition - Creation Products 1 through 5
0.3.2.2 Budget - Creation Products 1 through 5
0.3.2.3 Timing
0.3.2.4 Summary

0.3.3 Validation

0.3.3.1 Definition items 1 through y
0.3.3.2 Budget
0.3.3.3 Timing
0.3.3.4 Summary

0.3.4 Dimensional Summary

0.3.4.1 Overall Budget
0.3.4.2 ICON Page
0.3.4.3 Detailed Cost
0.3.4.4 Timing

0.4 Manufacturing Design/Build

0.4.1 Process Design

0.4.1.1 Plan

0.4.1.1.1 Lessons Learned Review
0.4.1.1.2 Definition - Requirements and

Brainstorming items 1 through x

0.4.1.1.3 Budget
0.4.1.1.4 Timing
0.4.1.1.5 Summary

0.4.1.2 Creation Products

0.4.1.2.1 Definition - Creation Products

1 though 5

0.4.1.2.2 Budget - Creation Products

1 though 5

0.4.1.2.3 Timing
0.4.1.2.4 Summary

0.4.1.3 Analysis

0.4.1.3.1 Creation Product 1

0.4.1.3.1.1 Definition - Analysis Item

1 - Lessons Learned

0.4.1.3.1.1.1 Budget

0.4.1.3.1.2 Definition - Analysis Item 2

0.4.1.3.1.2.1 Budget

0.4.1.3.1.3 Definition - Analysis Item 3

0.4.1.3.1.3.1 Budget

0.4.1.3.2 Creation Product 2

0.4.1.3.2.1 Definition - Analysis Item

1 - Lessons Learned

0.4.1.3.2.1.1 Budget

0.4.1.3.2.2 Definition - Analysis Item 2

0.4.1.3.2.2.1 Budget

0.4.1.3.2.3 Definition - Analysis Item 3

0.4.1.3.2.3.1 Budget

0.4.1.3.3 Creation Product 3

0.4.1.3.3.1 Definition - Analysis Item

1 - Lessons Learned

0.4.1.3.3.1.1 Budget

0.4.1.3.3.2 Definition - Analysis Item 2

0.4.1.3.3.2.1 Budget

0.4.1.3.3.3 Definition - Analysis Item 3

0.4.1.3.3.3.1 Budget

0.4.1.3.4 Creation Product 4

0.4.1.3.4.1 Definition - Analysis Item

1 - Lessons Learned

0.4.1.3.4.1.1 Budget

0.4.1.3.4.2 Definition - Analysis Item 2

0.4.1.3.4.2.1 Budget

0.4.1.3.4.3 Definition - Analysis Item 3

0.4.1.3.4.3.1 Budget

0.4.1.3.5 Timing
0.4.1.3.6 Summary

0.4.1.4 Design Aids

0.4.1.4.1 Creation Product 1

0.4.1.4.1.1 Definition - Design Aid Item 1

0.4.1.4.1.1.1 Budget

0.4.1.4.1.2 Definition - Design Aid Item 2

0.4.1.4.1.2.1 Budget

0.4.1.4.1.3 Definition - Design Aid Item 3

0.4.1.4.1.3.1 Budget

0.4.1.4.2 Creation Product 2

0.4.1.4.2.1 Definition - Design Aid Item 1

0.4.1.4.2.1.1 Budget

0.4.1.4.2.2 Definition - Design Aid Item 2

0.4.1.4.2.2.1 Budget

0.4.1.4.2.3 Definition - Design Aid Item 3

0.4.1.4.2.3.1 Budget

0.4.1.4.3 Creation Product 3

0.4.1.4.3.1 Definition - Design Aid Item 1

0.4.1.4.3.1.1 Budget

0.4.1.4.3.2 Definition - Design Aid Item 2

0.4.1.4.3.2.1 Budget

0.4.1.4.3.3 Definition - Design Aid Item 3

0.4.1.4.3.3.1 Budget

0.4.1.4.4 Creation Product 4

0.4.1.4.4.1 Definition - Design Aid Item 1

0.4.1.4.4.1.1 Budget

0.4.1.4.4.2 Definition - Design Aid Item 2

0.4.1.4.4.2.1 Budget

0.4.1.4.4.3 Definition - Design Aid Item 3

0.4.1.4.4.3.1 Budget

0.4.1.4.5 Timing
0.4.1.4.6 Summary

0.4.1.5 Validation

0.4.1.5.1 Definition items 1 through y
0.4.1.5.2 Budget
0.4.1.5.3 Timing
0.4.1.5.4 Summary

0.4.1.6 Implementation

0.4.1.6.1 Definition items 1 through z
0.4.1.6.2 Budget
0.4.1.6.3 Timing
0.4.1.6.4 Summary

0.4.1.7 Process Design Summary

0.4.1.7.1 Overall Budget
0.4.1.7.2 ICON Page
0.4.1.7.3 Detailed Cost
0.4.1.7.4 Timing

0.4.2 Tooling

0.4.2.1 Molds / Dies

0.4.2.1.1 Plan

0.4.2.1.1.1 Lessons Learned Review
0.4.2.1.1.2 Definition - Requirements

and Brainstorming items 1 through x

0.4.2.1.1.3 Budget
0.4.2.1.1.4 Timing
0.4.2.1.1.5 Summary

0.4.2.1.2 Creation Products

0.4.2.1.2.1 Definition - Creation Products 1

through 5

0.4.2.1.2.2 Budget - Creation Products

1 through 5

0.4.2.1.2.3 Timing
0.4.2.1.2.4 Summary

0.4.2.1.3 Analysis

0.4.2.1.3.1 Creation Product 1

0.4.2.1.3.1.1 Definition - Analysis Item

1 - Lessons Learned

0.4.2.1.3.1.1.1 Budget

0.4.2.1.3.2 Definition - Analysis Item 2

0.4.2.1.3.2.1.1 Budget

0.4.2.1.3.3 Definition - Analysis Item 3

0.4.2.1.3.3.1.1 Budget

0.4.2.1.3.4 Creation Product 2

0.4.2.1.3.4.1 Definition - Analysis Item

1 - Lessons Learned

0.4.2.1.3.4.1.1 Budget

0.4.2.1.3.4.2 Definition - Analysis

Item 2

0.4.2.1.3.4.2.1 Budget

0.4.2.1.3.4.3 Definition - Analysis

Item 3

0.4.2.1.3.4.3.1 Budget

0.4.2.1.3.5 Creation Product 3

0.4.2.1.3.5.1 Definition - Analysis Item

1 - Lessons Learned

0.4.2.1.3.5.1.1 Budget

0.4.2.1.3.5.2 Definition - Analysis

Item 2

0.4.2.1.3.5.2.1 Budget

0.4.2.1.3.5.3 Definition - Analysis

Item 3

0.4.2.1.3.5.3.1 Budget

0.4.2.1.3.6 Creation Product 4

0.4.2.1.3.6.1 Definition - Analysis Item

1 - Lessons Learned

0.4.2.1.3.6.1.1 Budget

0.4.2.1.3.6.2 Definition - Analysis

Item 2

0.4.2.1.3.6.2.1 Budget

0.4.2.1.3.6.3 Definition - Analysis

Item 3

0.4.2.1.3.6.3.1 Budget

0.4.2.1.3.7 Timing
0.4.2.1.3.8 Summary

0.4.2.1.4 Design Aids

0.4.2.1.4.1 Creation Product 1

0.4.2.1.4.1.1 Definition - Design Aid

Item 1

0.4.2.1.4.1.1.1 Budget

0.4.2.1.4.1.2 Definition - Design Aid

Item 2

0.4.2.1.4.1.2.1 Budget

0.4.2.1.4.1.3 Definition - Design Aid

Item 3

0.4.2.1.4.1.3.1 Budget

0.4.2.1.4.2 Creation Product 2

0.4.2.1.4.2.1 Definition - Design Aid

Item 1

0.4.2.1.4.2.1.1 Budget

0.4.2.1.4.2.2 Definition - Design Aid

Item 2

0.4.2.1.4.2.2.1 Budget

0.4.2.1.4.2.3 Definition - Design Aid

Item 3

0.4.2.1.4.2.3.1 Budget

0.4.2.1.4.3 Creation Product 3

0.4.2.1.4.3.1 Definition - Design Aid

Item 1

0.4.2.1.4.3.1.1 Budget

0.4.2.1.4.3.2 Definition - Design Aid

Item 2

0.4.2.1.4.3.2.1 Budget

0.4.2.1.4.3.3 Definition - Design Aid

Item 3

0.4.2.1.4.3.3.1 Budget

0.4.2.1.4.4 Creation Product 4

0.4.2.1.4.4.1 Definition - Design Aid

Item 1

0.4.2.1.4.4.1.1 Budget

0.4.2.1.4.4.2 Definition - Design Aid

Item 2

0.4.2.1.4.4.2.1 Budget

0.4.2.1.4.4.3 Definition - Design Aid

Item 3

0.4.2.1.4.4.3.1 Budget

0.4.2.1.4.5 Timing
0.4.2.1.4.6 Summary

0.4.2.1.5 Validation

0.4.2.1.5.1 Definition items 1 through y
0.4.2.1.5.2 Budget
0.4.2.1.5.3 Timing
0.4.2.1.5.4 Summary

0.4.2.1.6 Implementation

0.4.2.1.6.1 Definition items 1 through z
0.4.2.1.6.2 Budget
0.4.2.1.6.3 Timing
0.4.2.1.6.4 Summary

0.4.2.2 Secondary Operations

0.4.2.2.1 Plan

0.4.2.2.1.1 Lessons Learned Review
0.4.2.2.1.2 Definition - Requirements and

Brainstorming items 1 through x

0.4.2.2.1.3 Budget
0.4.2.2.1.4 Timing
0.4.2.2.1.5 Summary

0.4.2.2.2 Creation Products

0.4.2.2.2.1 Definition - Creation Products 1

through 5

0.4.2.2.2.2 Budget - Creation Products

1 through 5

0.4.2.2.2.3 Timing
0.4.2.2.2.4 Summary

0.4.2.2.3 Analysis

0.4.2.2.3.1 Creation Product 1

0.4.2.2.3.1.1 Definition - Analysis Item

1 - Lessons Learned

0.4.2.2.3.1.1.1 Budget

0.4.2.2.3.2 Definition - Analysis Item 2

0.4.2.2.3.2.1.1 Budget

0.4.2.2.3.3 Definition - Analysis Item 3

0.4.2.2.3.3.1.1 Budget

0.4.2.2.3.4 Creation Product 2

0.4.2.2.3.4.1 Definition - Analysis Item

1 - Lessons Learned

0.4.2.2.3.4.1.1 Budget

0.4.2.2.3.4.2 Definition - Analysis

Item 2

0.4.2.2.3.4.2.1 Budget

0.4.2.2.3.4.3 Definition - Analysis

Item 3

0.4.2.2.3.4.3.1 Budget

0.4.2.2.3.5 Creation Product 3

0.4.2.2.3.5.1 Definition - Analysis Item

1 - Lessons Learned

0.4.2.2.3.5.1.1 Budget

0.4.2.2.3.5.2 Definition - Analysis

Item 2

0.4.2.2.3.5.2.1 Budget

0.4.2.2.3.5.3 Definition - Analysis

Item 3

0.4.2.2.3.5.3.1 Budget

0.4.2.2.3.6 Creation Product 4

0.4.2.2.3.6.1 Definition - Analysis Item

1 - Lessons Learned

0.4.2.2.3.6.1.1 Budget

0.4.2.2.3.6.2 Definition - Analysis

Item 2

0.4.2.2.3.6.2.1 Budget

0.4.2.2.3.6.3 Definition - Analysis

Item 3

0.4.2.2.3.6.3.1 Budget

0.4.2.2.3.7 Timing
0.4.2.2.3.8 Summary

0.4.2.2.4 Design Aids

0.4.2.2.4.1 Creation Product 1

0.4.2.2.4.1.1 Definition - Design Aid

Item 1

0.4.2.2.4.1.1.1 Budget

0.4.2.2.4.1.2 Definition - Design Aid

Item 2

0.4.2.2.4.1.2.1 Budget

0.4.2.2.4.1.3 Definition - Design Aid

Item 3

0.4.2.2.4.1.3.1 Budget

0.4.2.2.4.2 Creation Product 2

0.4.2.2.4.2.1 Definition - Design Aid

Item 1

0.4.2.2.4.2.1.1 Budget

0.4.2.2.4.2.2 Definition - Design Aid

Item 2

0.4.2.2.4.2.2.1 Budget

0.4.2.2.4.2.3 Definition - Design Aid

Item 3

0.4.2.2.4.2.3.1 Budget

0.4.2.2.4.3 Creation Product 3

0.4.2.2.4.3.1 Definition - Design Aid

Item 1

0.4.2.2.4.3.1.1 Budget

0.4.2.2.4.3.2 Definition - Design Aid

Item 2

0.4.2.2.4.3.2.1 Budget

0.4.2.2.4.3.3 Definition - Design Aid

Item 3

0.4.2.2.4.3.3.1 Budget

0.4.2.2.4.4 Creation Product 4

0.4.2.2.4.4.1 Definition - Design Aid

Item 1

0.4.2.2.4.4.1.1 Budget

0.4.2.2.4.4.2 Definition - Design Aid

Item 2

0.4.2.2.4.4.2.1 Budget

0.4.2.2.4.4.3 Definition - Design Aid

Item 3

0.4.2.2.4.4.3.1 Budget

0.4.2.2.4.5 Timing
0.4.2.2.4.6 Summary

0.4.2.2.5 Validation

0.4.2.2.5.1 Definition items

1 through y

0.4.2.2.5.2 Budget
0.4.2.2.5.3 Timing
0.4.2.2.5.4 Summary

0.4.2.2.6 Implementation

0.4.2.2.6.1 Definition items

1 through z

0.4.2.2.6.2 Budget
0.4.2.2.6.3 Timing
0.4.2.2.6.4 Summary

0.4.2.3 Racks

0.4.2.3.1 Plan

0.4.2.3.1.1 Lessons Learned Review
0.4.2.3.1.2 Definition - Requirements and

Brainstorming items
1 through x

0.4.2.3.1.3 Budget
0.4.2.3.1.4 Timing
0.4.2.3.1.5 Summary

0.4.2.3.2 Creation Products

0.4.2.3.2.1 Definition - Creation Products 1

through 5

0.4.2.3.2.2 Budget - Creation Products

1 through 5

0.4.2.3.2.3 Timing
0.4.2.3.2.4 Summary

0.4.2.3.3 Analysis

0.4.2.3.3.1 Creation Product 1

0.4.2.3.3.1.1 Definition - Analysis Item

1 - Lessons Learned

0.4.2.3.3.1.1.1 Budget

0.4.2.3.3.2 Definition - Analysis Item 2

0.4.2.3.3.2.1.1 Budget

0.4.2.3.3.3 Definition - Analysis Item 3

0.4.2.3.3.3.1.1 Budget

0.4.2.3.3.4 Creation Product 2

0.4.2.3.3.4.1 Definition - Analysis Item

1 - Lessons Learned

0.4.2.3.3.4.1.1 Budget

0.4.2.3.3.4.2 Definition - Analysis

Item 2

0.4.2.3.3.4.2.1 Budget

0.4.2.3.3.4.3 Definition - Analysis

Item 3

0.4.2.3.3.4.3.1 Budget

0.4.2.3.3.5 Creation Product 3

0.4.2.3.3.5.1 Definition - Analysis Item

1 - Lessons Learned

0.4.2.3.3.5.1.1 Budget

0.4.2.3.3.5.2 Definition - Analysis

Item 2

0.4.2.3.3.5.2.1 Budget

0.4.2.3.3.5.3 Definition - Analysis

Item 3

0.4.2.3.3.5.3.1 Budget

0.4.2.3.3.6 Creation Product 4

0.4.2.3.3.6.1 Definition - Analysis Item

1 - Lessons Learned

0.4.2.3.3.6.1.1 Budget

0.4.2.3.3.6.2 Definition - Analysis

Item 2

0.4.2.3.3.6.2.1 Budget

0.4.2.3.3.6.3 Definition - Analysis

Item 3

0.4.2.3.3.6.3.1 Budget

0.4.2.3.3.7 Timing
0.4.2.3.3.8 Summary

0.4.2.3.4 Design Aids

0.4.2.3.4.1 Creation Product 1

0.4.2.3.4.1.1 Definition - Design Aid

Item 1

0.4.2.3.4.1.1.1 Budget

0.4.2.3.4.1.2 Definition - Design Aid

Item 2

0.4.2.3.4.1.2.1 Budget

0.4.2.3.4.1.3 Definition - Design Aid

Item 3

0.4.2.3.4.1.3.1 Budget

0.4.2.3.4.2 Creation Product 2

0.4.2.3.4.2.1 Definition - Design Aid

Item 1

0.4.2.3.4.2.1.1 Budget

0.4.2.3.4.2.2 Definition - Design Aid

Item 2

0.4.2.3.4.2.2.1 Budget

0.4.2.3.4.2.3 Definition - Design Aid

Item 3

0.4.2.3.4.2.3.1 Budget

0.4.2.3.4.3 Creation Product 3

0.4.2.3.4.3.1 Definition - Design Aid

Item 1

0.4.2.3.4.3.1.1 Budget

0.4.2.3.4.3.2 Definition - Design Aid

Item 2

0.4.2.3.4.3.2.1 Budget

0.4.2.3.4.3.3 Definition - Design Aid

Item 3

0.4.2.3.4.3.3.1 Budget

0.4.2.3.4.4 Creation Product 4

0.4.2.3.4.4.1 Definition - Design Aid

Item 1

0.4.2.3.4.4.1.1 Budget

0.4.2.3.4.4.2 Definition - Design Aid

Item 2

0.4.2.3.4.4.2.1 Budget

0.4.2.3.4.4.3 Definition - Design Aid

Item 3

0.4.2.3.4.4.3.1 Budget

0.4.2.3.4.5 Timing
0.4.2.3.4.6 Summary

0.4.2.3.5 Validation

0.4.2.3.5.1 Definition items

1 through y

0.4.2.3.5.2 Budget
0.4.2.3.5.3 Timing
0.4.2.3.5.4 Summary

0.4.2.3.6 Implementation

0.4.2.3.6.1 Definition items

1 through z

0.4.2.3.6.2 Budget
0.4.2.3.6.3 Timing
0.4.2.3.6.4 Summary

0.4.2.4 Fixtures

0.4.2.4.1 Plan

0.4.2.4.1.1 Lessons Learned Review
0.4.2.4.1.2 Definition - Requirements and

Brainstorming items 1
through x

0.4.2.4.1.3 Budget
0.4.2.4.1.4 Timing
0.4.2.4.1.5 Summary

0.4.2.4.2 Creation Products

0.4.2.4.2.1 Definition - Creation Products 1

through 5

0.4.2.4.2.2 Budget - Creation Products

1 through 5

0.4.2.4.2.3 Timing
0.4.2.4.2.4 Summary

0.4.2.4.3 Analysis

0.4.2.4.3.1 Creation Product 1

0.4.2.4.3.1.1 Definition - Analysis Item

1 - Lessons Learned

0.4.2.4.3.1.1.1 Budget

0.4.2.4.3.2 Definition - Analysis Item 2

0.4.2.4.3.2.1.1 Budget

0.4.2.4.3.3 Definition - Analysis Item 3

0.4.2.4.3.3.1.1 Budget

0.4.2.4.3.4 Creation Product 2

0.4.2.4.3.4.1 Definition - Analysis Item

1 - Lessons Learned

0.4.2.4.3.4.1.1 Budget

0.4.2.4.3.4.2 Definition - Analysis

Item 2

0.4.2.4.3.4.2.1 Budget

0.4.2.4.3.4.3 Definition - Analysis

Item 3

0.4.2.4.3.4.3.1 Budget

0.4.2.4.3.5 Creation Product 3

0.4.2.4.3.5.1 Definition - Analysis

Item 1 - Lessons Learned

0.4.2.4.3.5.1.1 Budget

0.4.2.4.3.5.2 Definition - Analysis

Item 2

0.4.2.4.3.5.2.1 Budget

0.4.2.4.3.5.3 Definition - Analysis

Item 3

0.4.2.4.3.5.3.1 Budget

0.4.2.4.3.6 Creation Product 4

0.4.2.4.3.6.1 Definition - Analysis

Item 1 - Lessons Learned

0.4.2.4.3.6.1.1 Budget

0.4.2.4.3.6.2 Definition - Analysis

Item 2

0.4.2.4.3.6.2.1 Budget

0.4.2.4.3.6.3 Definition - Analysis

Item 3

0.4.2.4.3.6.3.1 Budget

0.4.2.4.3.7 Timing
0.4.2.4.3.8 Summary

0.4.2.4.4 Design Aids

0.4.2.4.4.1 Creation Product 1

0.4.2.4.4.1.1 Definition - Design Aid

Item 1

0.4.2.4.4.1.1.1 Budget

0.4.2.4.4.1.2 Definition - Design Aid

Item 2

0.4.2.4.4.1.2.1 Budget

0.4.2.4.4.1.3 Definition - Design Aid

Item 3

0.4.2.4.4.1.3.1 Budget

0.4.2.4.4.2 Creation Product 2

0.4.2.4.4.2.1 Definition - Design Aid

Item 1

0.4.2.4.4.2.1.1 Budget

0.4.2.4.4.2.2 Definition - Design Aid

Item 2

0.4.2.4.4.2.2.1 Budget

0.4.2.4.4.2.3 Definition - Design Aid

Item 3

0.4.2.4.4.2.3.1 Budget

0.4.2.4.4.3 Creation Product 3

0.4.2.4.4.3.1 Definition - Design Aid

Item 1

0.4.2.4.4.3.1.1 Budget

0.4.2.4.4.3.2 Definition - Design Aid

Item 2

0.4.2.4.4.3.2.1 Budget

0.4.2.4.4.3.3 Definition - Design Aid

Item 3

0.4.2.4.4.3.3.1 Budget

0.4.2.4.4.4 Creation Product 4

0.4.2.4.4.4.1 Definition - Design Aid

Item 1

0.4.2.4.4.4.1.1 Budget

0.4.2.4.4.4.2 Definition - Design Aid

Item 2

0.4.2.4.4.4.2.1 Budget

0.4.2.4.4.4.3 Definition - Design Aid

Item 3

0.4.2.4.4.4.3.1 Budget

0.4.2.4.4.5 Timing
0.4.2.4.4.6 Summary

0.4.2.4.5 Validation

0.4.2.4.5.1 Definition items 1 through y
0.4.2.4.5.2 Budget
0.4.2.4.5.3 Timing
0.4.2.4.5.4 Summary

0.4.2.4.6 Implementation

0.4.2.4.6.1 Definition items 1 through z
0.4.2.4.6.2 Budget
0.4.2.4.6.3 Timing
0.4.2.4.6.4 Summary

0.4.2.5 Tooling Summary

0.4.2.5.1 Overall Budget
0.4.2.5.2 ICON Page
0.4.2.5.3 Detailed Cost
0.4.2.5.4 Timing

0.4.3 Facilities / Equipment

0.4.3.1 Plan

0.4.3.1.1 Lessons Learned Review
0.4.3.1.2 Definition - Requirements and

Brainstorming items 1 through x

0.4.3.1.3 Budget
0.4.3.1.4 Timing
0.4.3.1.5 Summary

0.4.3.2 Creation Products

0.4.3.2.1 Definition - Creation Products 1

through 5

0.4.3.2.2 Budget - Creation Products 1 through 5
0.4.3.2.3 Timing
0.4.3.2.4 Summary

0.4.3.3 Analysis

0.4.3.3.1 Creation Product 1

0.4.3.3.1.1 Definition - Analysis Item

1 - Lessons Learned

0.4.3.3.1.1.1 Budget

0.4.3.3.1.2 Definition - Analysis Item 2

0.4.3.3.1.2.1 Budget

0.4.3.3.1.3 Definition - Analysis Item 3

0.4.3.3.1.3.1 Budget

0.4.3.3.2 Creation Product 2

0.4.3.3.2.1 Definition - Analysis Item

1 - Lessons Learned

0.4.3.3.2.1.1 Budget

0.4.3.3.2.2 Definition - Analysis Item 2

0.4.3.3.2.2.1 Budget

0.4.3.3.2.3 Definition - Analysis Item 3

0.4.3.3.2.3.1 Budget

0.4.3.3.3 Creation Product 3

0.4.3.3.3.1 Definition - Analysis Item

1 - Lessons Learned

0.4.3.3.3.1.1 Budget

0.4.3.3.3.2 Definition - Analysis Item 2

0.4.3.3.3.2.1 Budget

0.4.3.3.3.3 Definition - Analysis Item 3

0.4.3.3.3.3.1 Budget

0.4.3.3.4 Creation Product 4

0.4.3.3.4.1 Definition - Analysis Item

1 - Lessons Learned

0.4.3.3.4.1.1 Budget

0.4.3.3.4.2 Definition - Analysis Item 2

0.4.3.3.4.2.1 Budget

0.4.3.3.4.3 Definition - Analysis Item 3

0.4.3.3.4.3.1 Budget

0.4.3.3.5 Timing
0.4.3.3.6 Summary

0.4.3.4 Design Aids

0.4.3.4.1 Creation Product 1

0.4.3.4.1.1 Definition - Design Aid Item 1

0.4.3.4.1.1.1 Budget

0.4.3.4.1.2 Definition - Design Aid Item 2

0.4.3.4.1.2.1 Budget

0.4.3.4.1.3 Definition - Design Aid Item 3

0.4.3.4.1.3.1 Budget

0.4.3.4.2 Creation Product 2

0.4.3.4.2.1 Definition - Design Aid Item 1

0.4.3.4.2.1.1 Budget

0.4.3.4.2.2 Definition - Design Aid Item 2

0.4.3.4.2.2.1 Budget

0.4.3.4.2.3 Definition - Design Aid Item 3

0.4.3.4.2.3.1 Budget

0.4.3.4.3 Creation Product 3

0.4.3.4.3.1 Definition - Design Aid Item 1

0.4.3.4.3.1.1 Budget

0.4.3.4.3.2 Definition - Design Aid Item 2

0.4.3.4.3.2.1 Budget

0.4.3.4.3.3 Definition - Design Aid Item 3

0.4.3.4.3.3.1 Budget

0.4.3.4.4 Creation Product 4

0.4.3.4.4.1 Definition - Design Aid Item 1

0.4.3.4.4.1.1 Budget

0.4.3.4.4.2 Definition - Design Aid Item 2

0.4.3.4.4.2.1 Budget

0.4.3.4.4.3 Definition - Design Aid Item 3

0.4.3.4.4.3.1 Budget

0.4.3.4.5 Timing
0.4.3.4.6 Summary

0.4.3.5 Validation

0.4.3.5.1 Definition items 1 through y
0.4.3.5.2 Budget
0.4.3.5.3 Timing
0.4.3.5.4 Summary

0.4.3.6 Implementation

0.4.3.6.1 Definition items 1 through z
0.4.3.6.2 Budget
0.4.3.6.3 Timing
0.4.3.6.4 Summary

0.4.3.7 Facilities Summary

0.4.3.7.1 Overall Budget
0.4.3.7.2 ICON Page
0.4.3.7.3 Detailed Cost
0.4.3.7.4 Timing

0.4.4 Manufacturing Design/Build Summary

0.4.4.1 Process Design

0.4.4.1.1 Overall Budget
0.4.4.1.2 ICON Page
0.4.4.1.3 Detailed Cost
0.4.4.1.4 Timing

0.4.4.2 Tooling

0.4.4.2.1 Overall Budget
0.4.4.2.2 ICON Page
0.4.4.2.3 Detailed Cost
0.4.4.2.4 Timing

0.4.4.3 Facilities

0.4.4.3.1 Overall Budget
0.4.4.3.2 ICON Page
0.4.4.3.3 Detailed Cost
0.4.4.3.4 Timing

0.5 Putting it Together

0.5.1 Business Plan

0.5.2 Product Design
0.5.3 Dimensional Integration
0.5.4 Manufacturing Design/Build

0.5.4.1 Process Design
0.5.4.2 Tooling
0.5.4.3 Facilities

0.6 Summary Reports

0.6.1 Budget Summary

0.6.1.1 Product Design
0.6.1.2 Dimensional Design
0.6.1.3 Manufacturing

0.6.1.3.1 Process Design
0.6.1.3.2 Tooling
0.6.1.3.3 Facilities

0.6.2 Cost Summary

0.6.2.1 Product Design
0.6.2.2 Dimensional
0.6.2.3 Manufacturing

0.6.2.3.1 Process Design
0.6.2.3.2 Tooling
0.6.2.3.3 Facilities

0.6.3 Timing Summary

0.6.3.1 Product Design
0.6.3.2 Dimensional
0.6.3.3 Manufacturing

0.6.3.3.1 Process Design
0.6.3.3.2 Tooling
0.6.3.3.3 Facilities

0.7 Total Program Summary

0.7.1 Total Budget
0.7.2 Total Cost
0.7.3 Total Timing

TABLE C
Menu for Section 01.0
(Business Plan)

01.1 Business Strategy

01.1.1 Background Information
01.1.2 Knowns
01.1.3 Questions
01.1.4 Plan

01.1.4.1 Corporate Strategy
01.1.4.2 Marketing Strategy
01.1.4.3 Product Strategy
01.1.4.4 Manufacturing Strategy
01.1.4.5 Supplier Strategy
01.1.4.6 Financial Strategy
01.1.4.7 Technology Strategy
01.1.4.8 Timing Chart / Worksheet to support Business Plan Milestones

and Product and Process Design Review Dates

01.1.5 Resolution Required

01.2 Product Description

01.2.1 Background Information
01.2.2 Knowns
01.2.3 Questions
01.2.4 Plan

01.2.4.1 Product Concepts
01.2.4.2 Product Content
01.2.4.3 Bill of Material
01.2.4.4 Material Strategy
01.2.4.5 Product Performance Criteria

01.2.5 Resolution Required
01.2.6 Timing Chart / Worksheet to Support Business Plan Milestones and

Product and Process Design Review Dates

01.3 Manufacturing Systems

01.3.1. Background Information
01.3.2. Knowns
01.3.3. Questions
01.3.4. Plan

01.3.4.1. Manufacturing Concepts

01.3.4.1.1. Operating Practice
01.3.4.1.2. Customer Focus
01.3.4.1.3. Empowered Workforce
01.3.4.1.4. Plan for Manufacturing Variables
01.3.4.1.5. Lean Manufacturing Practices
01.3.4.1.6. Quality Control Process
01.3.4.1.7. Just in Time Material Flow
01.3.4.1.8. Implementation Plan
01.3.4.1.9. Continuous Performance Improvement Plan

01.3.4.2. Manufacturing Content

01.3.4.2.1. Facility Requirements

01.3.4.2.1.1. Process Requirements
01.3.4.2.1.2. Tooling and Equipment Requirements
01.3.4.2.1.3. Preliminary Facility Layout

01.3.4.2.2. Technology Transfer

01.3.4.3. Bill Of Materials
01.3.4.4. Alternative Manufacturing Processes

01.3.4.4.1. Alternate Process Requirements
01.3.4.4.2. Alternate Tooling and Equipment Requirements
01.3.4.4.3. Alternate Facility Layout

01.3.4.5. Manufacturing Performance Criteria

01.3.4.5.1. Tooling Uptime
01.3.4.5.2. Equipment Uptime
01.3.4.5.3. Target Direct Labor
01.3.4.5.4. Work Content Target
01.3.4.5.5. Indirect Labor
01.3.4.5.6. Operator Cross-Training
01.3.4.5.7. Preventive Maintenance
01.3.4.5.8. Material On Hand and Inventory Turns

01.3.5. Resolution Required
01.3.6. Timing Chart / Worksheet to Support Business Plan Milestones and

| | Product and Process Design Review Dates |
|---|---|
| 01.4 | Program Management |

01.4.1. Background Information
01.4.2. Knowns
01.4.3. Questions
01.4.4. Plan

01.4.4.1. Integration Management
01.4.4.2. Scope Management
01.4.4.3. Time Management

01.4.4.3.1. Setup Sheet Timing Milestones
01.4.4.3.2. Business Plan Milestones
01.4.4.3.3. Engineering

01.4.4.4. Contract Administration
01.4.4.5. Quality Management

01.4.4.5.1. APQP Plan

01.4.4.5.1.1. GM
01.4.4.5.1.2. Ford
01.4.4.5.1.3. Daimler Chrysler

01.4.4.5.2. PPAP Plan

01.4.4.6. Human Resource Management

01.4.4.6.1. Program Resource Summary
01.4.4.6.2. Launch Requirements
01.4.4.6.3. Plant Requirements

01.4.4.7. Communication Management
01.4.4.8. Risk Management
01.4.4.9. Procurement Management

01.4.5. Resolution Required
01.4.6. Timing Chart / Worksheet to Support Business Plan Milestones and

| | Product and Process Design Review Dates |
|---|---|
| 01.5 | Supplier Management |

01.5.1. Background Information
01.5.2. Knowns
01.5.3. Questions
01.5.4. Plan

01.5.4.1. Purchased Part Listing
01.5.4.2. Supplier Development Requirements
01.5.4.3. Supplier Management

01.5.4.3.1. Quality Targets
01.5.4.3.2. Price Targets
01.5.4.3.3. Timing
01.5.4.3.4. Logistics
01.5.4.3.5. Tooling Targets
01.5.4.3.6. Price Reduction

01.5.4.3.6.1. Score
01.5.4.3.6.2. Tier 3 Sourcing

01.5.4.4. Long Term Agreements
01.5.4.5. Dimensional Management
01.5.4.6. Electronic Integration
01.5.4.7. Timing Chart / Worksheet to Support Business Plan Milestones

and Product and Process Design Review Dates

01.5.5. Resolution Required

01.6 Timing and Scheduling

01.6.1. Background Information
01.6.2. Knowns
01.6.3. Questions
01.6.4. Plan

01.6.4.1. Key Customer Milestones
01.6.4.2. Key Business Plan Milestones and Program Review Dates

01.6.4.2.1. Program Review 1
01.6.4.2.2. Program Review 2
01.6.4.2.3. Program Review 3
01.6.4.2.4. Program Review 4
01.6.4.2.5. Program Review 5
01.6.4.2.6. Program Review 6
01.6.4.2.7. Program Review 7

01.6.4.3. Product and Process Design Review Dates

01.6.4.3.1. Product and Process Requirements Design Review
01.6.4.3.2. Product and Process Alternative Selection Design Review
01.6.4.3.3. Conformance to Product and Process Requirements Design

Review

01.6.4.3.4. Prototype Release Readiness Design Review
01.6.4.3.5. Prototype Performance Design Review
01.6.4.3.6. Production Release Completion Design Review
01.6.4.3.7. Validation Sign-off Design Review

01.6.4.4. Timing Chart / Worksheet to Support Business Plan Milestones

and Product and Process Design Review Dates

01.6.5. Resolution Required

01.7 Business / Financial

01.7.1. Background Information
01.7.2. Knowns
01.7.3. Questions
01.7.4. Plan

01.7.4.1. Financial Information

01.7.4.1.1. Program Summary

01.7.4.1.1.1. Manufacturing
01.7.4.1.1.2. Tooling

01.7.4.1.1.2.1. Molds / Dies
01.7.4.1.1.2.2. Secondary Operations
01.7.4.1.1.2.3. Racks
01.7.4.1.1.2.4. Fixtures

01.7.4.1.1.3. Product Engineering Summary
01.7.4.1.1.4. Manufacturing Engineering Summary
01.7.4.1.1.5. Cost Down Offset
01.7.4.1.1.6. Total Program Summary

01.7.4.1.2. Manufacturing Detail

01.7.4.1.2.1. Plant Contribution by Calendar Year
01.7.4.1.2.2. Sales by Calendar Year
01.7.4.1.2.3. Cash Flow
01.7.4.1.2.4. Capital Requirements
01.7.4.1.2.5. Amortization

01.7.4.1.3. Tooling Details

01.7.4.1.3.1. Molds / Dies

01.7.4.1.3.1.1. Plant Contribution by Calendar Year
01.7.4.1.3.1.2. Sales By Calendar Year
01.7.4.1.3.1.3. Cash Flow
01.7.4.1.3.1.4. Capital Requirements
01.7.4.1.3.1.5. Amortization

01.7.4.1.3.2. Secondary Operations

01.7.4.1.3.2.1. Plant Contribution by Calendar Year
01.7.4.1.3.2.2. Sales By Calendar Year
01.7.4.1.3.2.3. Cash Flow
01.7.4.1.3.2.4. Capital Requirements
01.7.4.1.3.2.5. Amortization

01.7.4.1.3.3. Racks

01.7.4.1.3.3.1. Plant Contribution by Calendar Year
01.7.4.1.3.3.2. Sales By Calendar Year
01.7.4.1.3.3.3. Cash Flow
01.7.4.1.3.3.4. Capital Requirements
01.7.4.1.3.3.5. Amortization

01.7.4.1.3.4. Fixtures

01.7.4.1.3.4.1. Plant Contribution by Calendar Year
01.7.4.1.3.4.2. Sales By Calendar Year
01.7.4.1.3.4.3. Cash Flow
01.7.4.1.3.4.4. Capital Requirements
01.7.4.1.3.4.5. Amortization

01.7.4.1.4. Product Engineering Details

01.7.4.1.4.1. Plant Contribution by Calendar Year
01.7.4.1.4.2. Sales By Calendar Year
01.7.4.1.4.3. Cash Flow
01.7.4.1.4.4. Capital Requirements
01.7.4.1.4.5. Amortization

01.7.4.1.5. Manufacturing Engineering Details

01.7.4.1.5.1. Plant Contribution by Calendar Year
01.7.4.1.5.2. Sales By Calendar Year
01.7.4.1.5.3. Cash Flow
01.7.4.1.5.4. Capital Requirements
01.7.4.1.5.5. Amortization

01.7.4.2. Piece Cost Development

01.7.4.2.1. Worksheets
01.7.4.2.2. Summary

01.7.4.3. Tooling Cost Development

01.7.4.3.1. Molds / Dies

01.7.4.3.1.1. Worksheets
01.7.4.3.1.2. Summary

01.7.4.3.2. Secondary Operations

01.7.4.3.2.1. Worksheets
01.7.4.3.2.2. Summary

01.7.4.3.3. Racks

01.7.4.3.3.1. Worksheets
01.7.4.3.3.2. Summary

01.7.4.3.4. Fixtures

01.7.4.3.4.1. Worksheets
01.7.4.3.4.2. Summary

01.7.4.4. Product Development Budgets

01.7.4.4.1. Budget Detail
01.7.4.4.2. Budget Allocation

01.7.4.5. Quote / Contract Agreement

01.7.4.5.1. Piece Cost
01.7.4.5.2. Tooling

01.7.4.5.2.1. Molds / Dies
01.7.4.5.2.2. Secondary Operations
01.7.4.5.2.3. Racks
01.7.4.5.2.4. Fixtures

01.7.4.6. Design Target Specification

01.7.4.6.1. Material Design Cost
01.7.4.6.2. Manufacturing Labor Costs
01.7.4.6.3. Equipment Cycle Time
01.7.4.6.4. Capital

01.7.4.6.4.1. Program
01.7.4.6.4.2. Product
01.7.4.6.4.3. Dimensional
01.7.4.6.4.4. Manufacturing

01.7.4.7. Timing Chart / Worksheet to Support Business Plan Milestones

and Product and Process Design Review Dates

01.7.5. Resolution Required

01.8 Technology Transfer

01.8.1. Background Information
01.8.2. Knowns
01.8.3. Questions
01.8.4. ISO 9000 Certification

01.8.4.1. Background Information
01.8.4.2. Purpose
01.8.4.3. Types of ISO Certification
01.8.4.4. The 20 ISO Clauses

01.8.4.4.1. ISO Section 4.1 Management Responsibility
01.8.4.4.2. ISO Section 4.2 Quality System
01.8.4.4.3. ISO Section 4.3 Contract Review
01.8.4.4.4. ISO Section 4.4 Design Control
01.8.4.4.5. ISO Section 4.5 Document and Data Control
01.8.4.4.6. ISO Section 4.6 Purchasing
01.8.4.4.7. ISO Section 4.7 Control of Customer-supplied Product
01.8.4.4.8. ISO Section 4.8 Product Identification and Traceability
01.8.4.4.9. ISO Section 4.9 Process Control
01.8.4.4.10. ISO Section 4.10 Inspection and Testing
01.8.4.4.11. ISO Section 4.11 Control of Inspection, Measuring and

Test Equipment

01.8.4.4.12. ISO Section 4.12 Inspection and Test Status
01.8.4.4.13. ISO Section 4.13 Control of Non-Conforming Product
01.8.4.4.14. ISO Section 4.14 Corrective and Preventive Action
01.8.4.4.15. ISO Section 4.15 Handling, Storage and Delivery
01.8.4.4.16. ISO Section 4.16 Control of Quality Records
01.8.4.4.17. ISO Section 4.17 Internal Quality Audits
01.8.4.4.18. ISO Section 4.18 Training
01.8.4.4.19. ISO Section 4.19 Servicing
01.8.4.4.20. ISO Section 4.20 Statistical Techniques

01.8.4.5. Auditing and Registration Process

01.8.4.5.1. External Audits
01.8.4.5.2. Internal Audits
01.8.4.5.3. Auditing Method

01.8.4.6. Steps to Prepare for ISO Registration

01.8.4.6.1. Educate the Workforce and Identify the Auditors
01.8.4.6.2. Provide Training and Implement Internal Auditing

01.8.4.6.2.1. Internal Auditor Specialized Training Page 1
01.8.4.6.2.2. Internal Auditor Specialized Training Page 2
01.8.4.6.2.3. Internal Auditor Specialized Training Page 3
01.8.4.6.2.4. Internal Auditor Specialized Training Page 4

01.8.4.6.3. Conduct Audits and Continuously Improve

01.8.4.7. Registration Philosophy

01.8.4.7.1. Plan Your Work

01.8.4.7.1.1. Quality Manual Work Products

01.8.4.7.1.1.1. Company Quality Policy
01.8.4.7.1.1.2. Company Organizational Structure
01.8.4.7.1.1.3. Company's Approach to Meeting Their

Customer's Requirements

01.8.4.7.1.1.4. Company's Documentation Structure
01.8.4.7.1.1.5. Other Policies & Responsibilities of Management

01.8.4.7.1.2. Quality Procedure
01.8.4.7.1.3. Work Process
01.8.4.7.1.4. Quality Records

01.8.4.7.2. Work Your Plan
01.8.4.7.3. Continuous Improvement

01.8.4.8. Training Verification Worksheet

01.8.5. Plan

01.8.5.1. Hardware
01.8.5.2. Software
01.8.5.3. Training
01.8.5.4. Timing Chart / Worksheet to Support Business Plan Milestones

and Product and Process Design Review Dates

01.8.6. Resolution Required

What is claimed is:

1. A method for developing a product comprising the steps of generating an estimate of the cost of developing and manufacturing the product; and
developing a plan to manufacture the product including parallel stages of product design, dimensional integration and manufacturing processes.

2. The method of claim 1 wherein the step of generating the estimate comprises the step of:
providing at least two distinct levels of information to support each one of a data entry field in the estimate, each level increasing in detail from a broad first level.

3. The method of claim 1 wherein the step of developing the plan includes the steps of:
defining customer deliverables;
defining aids to create the customer deliverables; and
defining analysis steps to support the deliverables.

4. The method of claim 3 wherein each of the steps of defining customer deliverables, aids and analysis are divided into sequential time cells.

5. The method of claim 1 further comprising:
providing a plurality of menu selectable screen templates for displaying required information in each stage of the plan.

6. A method of product development comprising the steps of:
generating an estimate of the cost of developing and manufacturing a product in response to a request for estimate for setting product requirements, the step of generating the estimate including:
providing at least two distinct levels of estimate information to support each one of a data entry field in the estimate, each level increasing in detail from a broad first level through each successive lower level.
